(19) United States
(12) Patent Application Publication
(10) Pub. No.: US 2026/0043463 A1
(43) Pub. Date: Feb. 12, 2026

(54) LIGHTWEIGHT AND LOW NOISE GEAR ASSEMBLY

(71) Applicant: Eaton Intelligent Power Limited, Dublin 4 (IE)

(72) Inventors: Carlos Henrique WINK, Portage, MI (US); Bruno Cesar MUSSULINI, Valinhos-SP (BR); André Luis DE ARAUJO MARQUES LEAO, Paulfnia - SP (BR); Natasha Queiroz NOGUEIRA DE SOUZA, Sao Paulo (BR); Paulo Roberto TEIXEIRA DA SILVA, Campinas-SP (BR); Marco Aurelio LUIZ DE OLIVERIA, Valinhos (BR)

(21) Appl. No.: 19/307,448

(22) Filed: Aug. 22, 2025

Related U.S. Application Data
(63) Continuation-in-part of application No. 18/690,590.
(60) Provisional application No. 63/242,563, filed on Sep. 10, 2021.

(51) Int. Cl. F16H 55/18; F16H 55/06; F16H 55/08

(52) U.S. Cl. CPC F16H 55/18; F16H 55/06; F16H 55/0846

(57) ABSTRACT

A lightweight and low noise gear assembly includes a gear assembly that includes a hub, at least one disc, and a ring gear component, wherein two or more of the hub, the at least one disc and the ring gear component are welded together. A lightweight and low noise gear assembly includes a shaft assembly that includes a ring gear, and at least one disc joined with the ring gear. A method of forming a gear assembly, the gear assembly including a hub, at least one disc, and a ring gear component, the method including press-fitting the at least one disc onto the hub and the ring gear, and welding the at least one disc and the ring gear to the hub.

### CROSS-REFERENCE TO RELATED APPLICATION

This application is a continuation in part of U.S. patent application Ser. No. 18/690,590, filed on Sep. 9, 2022, which claims the benefit of U.S. Provisional Application Ser. No. 63/242,563, filed Sep. 10, 2021, the disclosures of which are hereby incorporated by reference in their entirety.

### FIELD OF THE INVENTION

Examples of this disclosure are directed to a gear assembly that includes a ring gear, a hub, and one or more thin discs that may be welded to the hub and the ring gear.

### SUMMARY

One aspect of examples of the present disclosure includes a gear assembly that includes a hub, at least one disc, and a ring gear component, wherein two or more of the hub, the at least one disc, and the ring gear component are welded together. In examples, the hub, the at least one disc, and the ring gear component are welded together at a plurality of weld joints. In an example, the weld joints are at a plurality of locations of the gear. For example, the at least one disc is a circular member. In another example, the at least one disc includes at least one of an ASTM A572 material and a 8620 steel material. In yet another example, one of the hub, the at least one disc, and the ring gear component includes a different material from another of the hub, the at least one disc, and the ring gear component. In other examples, a relief is included between the hub and the at least one disc. For example, the relief has a size of about 1.5 millimeters and is inclined at an angle of about 15 degrees. As another example, the relief is configured to enable the at least one disc and the hub to maintain their respective positions during a welding operation thereof.

In other examples of the above aspect, the hub includes a plurality of steps configured to position the at least one disc relatively to the hub during a welding operation thereof. In an example, the at least one disc includes a single disc. In another example, the at least one disc includes a dual disc configuration, the dual disc configuration including a first disc having a first thickness and a second disc having a second thickness lower than the first thickness. For example, an orientation of the second disc is parallel to an orientation of the first disc. In other examples, the at least one disc includes a dual disc configuration, the dual disc configuration including a first disc and a second disc having a same thickness as the first disc. In yet another example, the first disc and the second disc are oriented so that the first disc and the second disc cross each other.

In further examples of the above aspect, the at least one disc includes a triple disc configuration, the triple disc configuration including a first disc having a first thickness, a second disc having a second thickness, and a third disk having a third thickness. In a further example, the third disc has a shape of a truncated circular cone. In yet another example, the first thickness, the second thickness, and the third thickness are equal to each other. In other examples, the second thickness is lower than the first thickness and lower than the third thickness. In an example, a weight of the gear assembly is in a range of 3.75 Kg to 4.945 Kg. In another example, a vibration noise of the gear assembly is in a range of 106-134 dB. In further examples, a first harmonic of the vibration noise is equal to about 134 dB, a second harmonic of the vibration noise is equal to about 123 dB, and a third harmonic of the vibration noise is equal to about 106 dB.

Another aspect of examples of the present disclosure includes a shaft assembly that includes a ring gear and at least one disc joined with the ring gear. For example, the at least one disc is joined with the ring gear via at least one of adhering and welding. As another example, the shaft assembly does not include a hub.

Another aspect of examples of the present disclosure includes a method of forming a gear assembly, the gear assembly including a hub, at least one disc, and a ring gear component, the method including press-fitting the at least one disc onto the hub and the ring gear, and welding the at least one disc and the ring gear to the hub. In various examples, the gear assembly further includes a relief between the hub and the at least one disc, and welding the at least one disc and the ring gear to the hub includes applying a welding bead on the relief. In other examples, the hub includes a plurality of steps, and press-fitting the at least one disc onto the hub and the ring gear includes positioning the at least one disc relatively to the hub at the plurality of steps.

Another aspect of the present disclosure a gear and shaft assembly comprising includes a shaft extending along a longitudinal axis and presenting an outer surface; a ring gear presenting an inner surface and having a plurality of radially outward facing teeth; a first disc component defining a radial inner end attached to the shaft outer surface and defining a radial outer end attached to the ring gear inner surface at an outer radial end, the radial outer end defining an axially extending portion; a second disc component defining a radial inner end attached to the shaft outer surface and defining a radial outer end attached to the ring gear inner surface at an outer radial end, the radial outer end defining an axially extending portion; wherein the axially extending portions of the first and second disc are welded to ring gear.

In an aspect, the radial outer end of the first disc component extends in a first axial direction.

In an aspect, the radial outer end of the second disc component extends in a second axial direction.

In another aspect, the radial inner ends of the first and second disc components are welded to the shaft.

In an aspect, the first and second disc components are identical to each other and are mirrored relative to each other.

In an aspect, the shaft includes a circumferential protrusion having a flat surface opposite the inner surface of the ring gear.

In an aspect, the circumferential protrusion is angled to an outermost circumference, and wherein the circumferential protrusion includes a shoulder defined between the outermost circumference and the flat, wherein the first radial ends are coupled to the flat surface and the shoulder.

In an aspect, the first and second disc components are oriented so that the first and second disc components are welded together along a radially extending surface.

Another aspect of the present disclosure is a gear and shaft assembly comprising: a shaft extending between a first end and a second end; a ring gear; and at least one disc operatively coupling the ring gear to the shaft and extending between a first radial end proximate the shaft and a second radial end proximate the ring gear, wherein the second radial end extend in an axial direction towards the shaft first end, and wherein the at least one disc has a middle portion defining a recess extending in a direction toward the shaft second end.

In an aspect, the first radial end of the at least one disc is directly attached to the shaft and extends in an axial direction towards the first shaft end.

In an aspect, the second radial end of the at least one disc is directly attached to the ring gear.

In an aspect, the at least one disc is a single disc.

In an aspect, the single disc has a C-shaped cross-sectional shape.

In an aspect, the single disc has an X-shaped cross-sectional shape.

In an aspect, the at least one disc comprises a dual disc configuration, the dual disc configuration comprising a first disc; and a second disc joined to the first disc.

In an aspect, the first disc and the second disc are oriented so that the first disc and the second disc are joined along a radially extending surface.

In an aspect, the first disc and the second disc are identical to each other.

In an aspect, each disc has a first side and a second side separated by a thickness, and wherein each disc is attached to both the ring gear and the shaft on the first side.

In an aspect, the second radial ends are curved to define an axially extending portion.

In an aspect, the shaft includes a circumferential protrusion having a flat surface opposite an inner surface of the ring gear, and wherein the first radial ends are coupled to the flat surface and the shoulder

### BRIEF DESCRIPTION OF THE DRAWINGS

The aspects set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a cross section of a gear assembly having a conventional design.

FIG. 2 depicts a gear and shaft assembly having a conventional design.

FIG. 3A depicts a gear assembly that addresses and overcomes the deficiencies of conventional gear assemblies, according to one or more embodiments described and illustrated herein.

FIG. 3B depicts a schematic representation of the hub, the disc, the ring gear component, and the gear assembly of the present disclosure, according to one or more embodiments described and illustrated herein.

FIG. 4 depicts a countershaft of the present disclosure that addresses and overcomes the deficiencies of the gear and the shaft assembly having a conventional design, according to one or more embodiments described and illustrated herein.

FIG. 5A depicts an example embodiment of a single-disc design of the gear assembly of the present disclosure that addresses and overcomes the deficiencies of the gear assemblies having a conventional design, according to one or more embodiments described and illustrated herein.

FIG. 5B depicts an example embodiment of a dual-disc design of the gear assembly of the present disclosure that addresses and overcomes the deficiencies of the gear assemblies having the conventional design, according to one or more embodiments described and illustrated herein.

FIG. 5C depicts an example embodiment of a triple-disc design of the gear assembly of the present disclosure that addresses and overcomes the deficiencies of the gear assemblies having the conventional design, according to one or more embodiments described and illustrated herein.

FIG. 5D depicts a dual cone design of the gear assembly of the present disclosure that addresses and overcomes the deficiencies of gear assemblies having conventional design, according to one or more embodiments described and illustrated herein.

FIG. 5E depicts an example image of a machined gear assembly having the dual cone design of the present disclosure, according to one or more embodiments described and illustrated herein.

FIG. 6 depicts an example positioning of the gear assembly within a transmission of a vehicle, according to one or more embodiments described and illustrated herein.

FIG. 7 depicts an example of a conventional electrical vehicle drive unit in which a conventional gear assembly is positioned.

FIG. 8 depicts an example electric vehicle drive unit in which an example gear assembly is positioned.

FIG. 9 depicts an example graphical representation of dynamic responses of a conventional gear assembly as compared to dynamic responses of the gear assembly as described in the present disclosure, according to one or more embodiments described and illustrated herein.

FIG. 10 depicts another example graphical representation of dynamic responses of a conventional gear assembly as compared to dynamic responses of the gear assembly that were measured using an accelerometer positioned on an enclosure of each of the conventional gear assemblies and the gear assembly of the present disclosure, according to one or more embodiments described and illustrated herein.

FIG. 11 depicts a perspective view an example embodiment of a gear and shaft assembly and a dual disc assembly.

FIG. 12 is a second perspective view of the gear and shaft assembly of FIG. 11.

FIG. 13 is an exploded perspective view of the gear and shaft assembly of FIG. 11.

FIG. 14 is a second exploded perspective view of the gear and shaft assembly of FIG. 11.

FIG. 15 is an exploded side view of the gear and shaft assembly of FIG. 11.

FIG. 16 is a perspective view of the ring gear and dual disc assembly of FIG. 11.

FIG. 17 is a second perspective view of the ring gear and dual disc assembly of FIG. 16.

FIG. 18 is front view of the ring gear and dual disc assembly of FIG. 16.

FIG. 19 is a perspective view of the dual disc assembly of FIG. 16.

FIG. 20 is a side view of the dual disc assembly of FIG. 16.

FIG. 21 is a second perspective view of the dual disc assembly of FIG. 16.

FIG. 22 is a perspective cross sectional view of the shaft assembly of FIG. 11.

FIG. 23 is a cross sectional perspective view of the shaft assembly of FIG. 11.

FIG. 24 is an alternate embodiment of a gear and shaft assembly having a dual disc assembly.

FIG. 25 is an alternate example of a gear and shaft assembly having a dual disc assembly of FIG. 24.

FIG. 26 is an alternate example of a gear and shaft assembly having a dual disc assembly of FIG. 24.

FIG. 27 is an alternate example of a gear and shaft assembly having a dual disc assembly of FIG. 24.

FIG. 28 is a perspective view of an alternate embodiment of a gear and shaft assembly with a single disc.

FIG. 29 is a second perspective view of the gear and shaft assembly of FIG. 28.

FIG. 30 is an exploded perspective view of the gear and shaft assembly of FIG. 28.

FIG. 31 is an exploded side view of the gear and shaft assembly of FIG. 28.

FIG. 32 is a perspective view of the ring gear and disc of FIG. 28.

FIG. 33 is a second perspective view of the ring gear and disc of FIG. 32.

FIG. 34 is front view of the ring gear and disc of FIG. 32.

FIG. 35 is a perspective view of the disc of FIG. 32.

FIG. 36 is a perspective cross sectional view of the gear and shaft assembly of FIG. 32.

FIG. 37 is a cross sectional view of the ring gear and disc of FIG. 32.

FIG. 38 is a cross sectional view of the gear and shaft assembly and disc of FIG. 28.

FIG. 39 is an enlarged view of the view shown at FIG. 38, with a curved portion of the disc adjacent to the gear.

FIG. 40 is an alternate example of the disc of FIG. 28 with a curved portion of the disc adjacent to the shaft.

FIG. 41 is an alternate example of the disc assembly of FIG. 28 with a symmetrical curve.

FIG. 42 is a perspective view of an alternate embodiment of a gear and shaft assembly with a dual disc configuration.

FIG. 43 is a second perspective view of the gear and shaft assembly of FIG. 42.

FIG. 44 is an exploded perspective view of the gear and shaft assembly of FIG. 42.

FIG. 45 is an exploded side view of the gear and shaft assembly of FIG. 42.

FIG. 46 is a perspective view of the discs of FIG. 42.

FIG. 47 is a second perspective view of the discs of FIG. 42.

FIG. 48 is front view of the ring gear and discs of FIG. 42.

FIG. 49 is a perspective cross-sectional view of the gear and shaft assembly of FIG. 42.

FIG. 50 is a cross sectional view of the gear and shaft assembly of FIG. 42.

FIG. 51 is a perspective view of an alternate embodiment of a gear and shaft assembly with a dual disc configuration.

FIG. 52 is a cross sectional view of the shaft assembly and dual disc configuration of FIG. 51.

### DETAILED DESCRIPTION

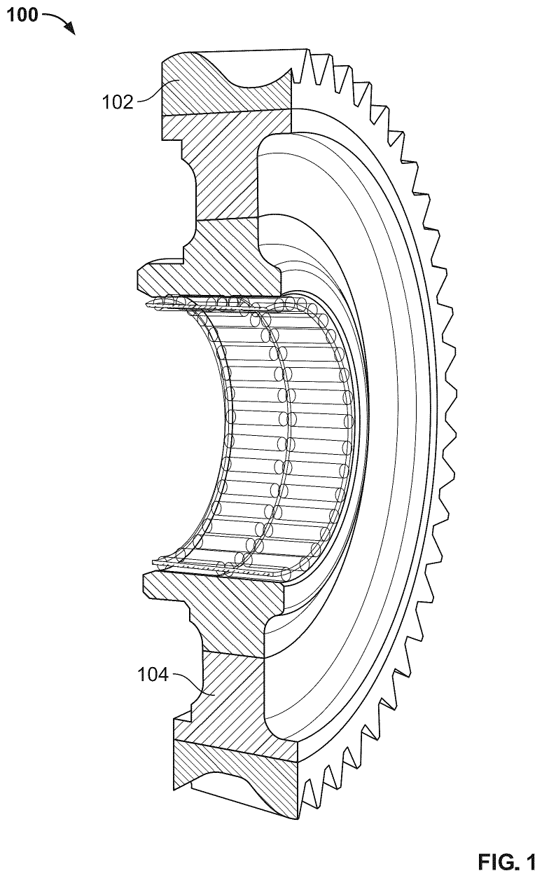

Conventional gear assemblies are typically formed of the same material and have a web and rim based geometry, as illustrated in FIG. 1. These gear assemblies have a number of shortcomings. In particular, conventional gear assemblies are typically heavy and have suboptimal noise, vibration, and harshness (“NVH”) characteristics, primarily due to limitations associated with manufacturing processes such as, e.g., the heat treatment distortions that are needed to manufacture these assemblies. The gear assembly as described in the present disclosure addresses and overcomes these deficiencies. In particular, the gear assembly as described in the present disclosure is light weight and designed such that the NVH characteristics of the assembly is better than the NVH characteristics of conventional gear assemblies. Additionally, it is noted that various finishing operations such as internal diameter grinding, hard finishing of tooth flanks, and so forth, are performed after the gear assembly is assembled.

In various examples, the gear assembly of the present disclosure, during operation, has lower NVH characteristics as compared to conventional gear assemblies, due to, e.g., the geometry of the components included as part of the gear assembly such as, e.g., the geometries of the hub, disc, ring gear components. The manner in which these components are joined to each other may also facilitate a reduction in the NVH characteristics. In other examples, the gear assembly of the present disclosure has better NVH characteristics as compared to the conventional gear assembly due to, e.g., the geometries of each of the hub, disc, and ring gear enabling the gear assembly to be more flexible as compared to conventional gear assemblies.

Other examples of the present disclosure include a lightweight, low-noise gear assembly concept that consists of, or includes, a ring gear, a hub, and one or more thin discs. For example, the thin discs are welded to the ring gear and hub to create a lightweight, low noise gear assembly. Accordingly, the ring gear and discs may be welded directly to the shaft for additional weight and cost reduction. Various examples of this disclosure provide a solution for significant weight reduction of gears and shafts, along with noise reduction. For example, the example gear assembly according to the examples of this disclose result in a 25% to 46% weight reduction, and a 2 dB to 5 dB noise reduction compared to a conventional gear assembly. For example, the weight reduction can be translated into savings in material costs of the component, a longer range of useful life for, e.g., electric vehicles, and a higher payload for, e.g., commercial vehicles.

FIG. 1 depicts a cross section of a gear assembly having a conventional design. As illustrated, a cross section of a gear assembly 100 with a conventional design includes a rim 102 and a web configuration 104. Such conventional gears and gear assemblies are typically made of steel, and are manufactured by forging, machining, heat treatment, and hard finish. Conventional gears such as the gear illustrated in FIG. 1 typically suffer from a number of deficiencies. In particular, as a result of the manufacturing processes utilized to make the gear assemblies, these assemblies are typically bulky and have a significant weight. Additionally, as stated above, the conventional gears are noisy in operation.

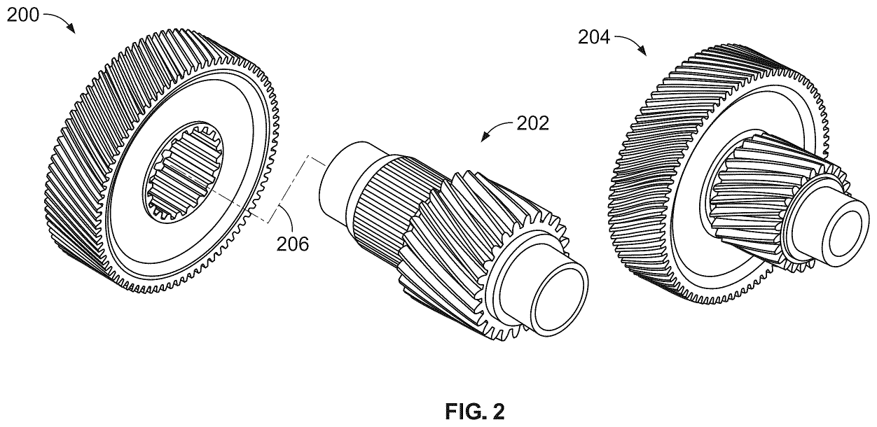

FIG. 2 depicts a gear and shaft assembly having a conventional design. In particular, FIG. 2 depicts an example design of a conventional gear 200, a conventional shaft 202, and a conventional intermediate shaft assembly 204 (i.e., a countershaft). The gear 200 and the shaft assembly 204 are illustrated as separate parts that are assembled or joined together along axis 206, which may involve the use of, e.g., a spline joint, a press fit, a keyway, or welding. The conventional gear 200 may also include a counter shaft or intermediate shaft 204 that is formed of a single piece (e.g., a single steel component). Due to manufacturing constraints, there may be a certain distance or interval between the conventional gear 200 and the conventional shaft 202.

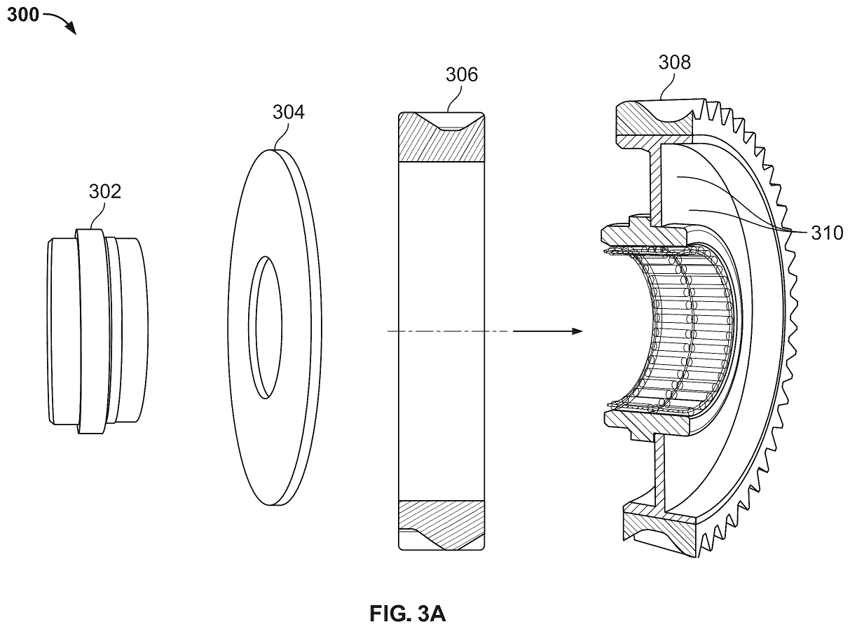

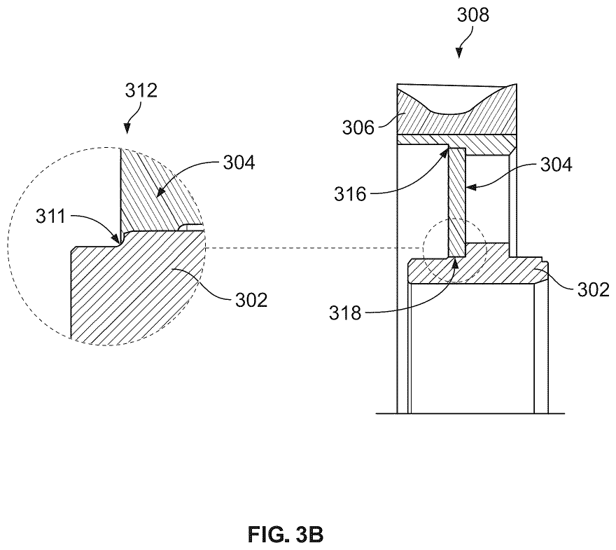

FIG. 3A depicts a gear assembly according to examples of the present disclosure. In particular, the gear assembly 300 may include a hub 302, a disc 304, a ring gear component 306, and a gear 308. The gear 308 may be formed by welding together the hub 302, the disc 304, and the ring gear component 306. The gear 308 may include a plurality of weld joints 310. The disc 304 is a thin, circular member that may be formed of material such as, e.g., ASTM A572, or other comparable materials. In various examples, different materials may be utilized to form each of the hub 302, the disc 304, and the ring gear 306, as each of these components may have varying strength requirements or strength profiles. As such, some components may be formed of materials that are cheaper than the materials used to form the other components, and as a result, the overall cost of the gear assembly 300 may be lowered compared to a conventional gear assembly. In various examples, weld joints such as weld joints 310, may be positioned on other portions of the gear 308 as well.

FIG. 3B depicts a schematic representation of the hub 302, the disc 304, the ring gear component 306, and the gear 308, according to various examples of this disclosure. In embodiments, laser welding operations may be performed such that the disc 304 may be lightly press fitted onto the hub 302 and the ring gear 306, and permanently attached by welding. In various examples, prior to performing the welding and assembly operation, a hardened case may be removed from the area in which the hub 302, the disc 304, and the ring gear component 306 interface. Schematic 312 illustrates the disc 304 and the hub 302 interfacing with each other. In an example, there is a relief 311 between the hub 302 and the disc 304, the relief 311 measuring approximately, e.g., 1.5 millimeters, and having an angle of approximately, e.g., 15 degrees. The relief 311 may be configured to enable the laser welding operation, in particular, to enable the laser weld to apply a bead. In examples, the relief 311 provides a manufacturing tolerance that enables a laser welding operation. The relief 311 may also enable the disc 304 and the hub 302 to maintain their respective positions while the welding operation is performed. In examples, when the disc 304 is press fitted against the hub 302, steps 316, 318, provided at multiple locations on the hub 302, enable the disc 304 to be appropriately positioned relative to the hub 302 while the welding operation is performed.

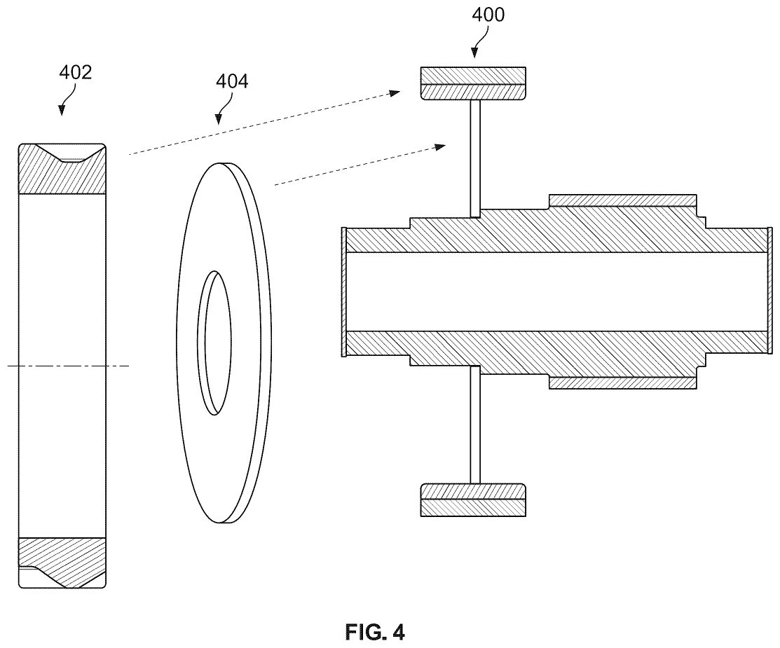

FIG. 4 depicts a countershaft or intermediate shaft assembly, according to examples of the present disclosure, that addresses and overcomes the deficiencies of the gear and the shaft assembly having a conventional design. In particular, FIG. 4 depicts an example countershaft or shaft assembly 400, which may include an example ring gear 402 and an example thin disc 404. In various examples, the countershaft or shaft assembly 400 may be formed by joining, adhering, or combining the ring gear 402 with the thin disc 404. In examples, the countershaft or shaft assembly 400 lacks a hub, which reduces the weight of the countershaft or shaft assembly 400, resulting in improved NVH characteristics and increased cost savings.

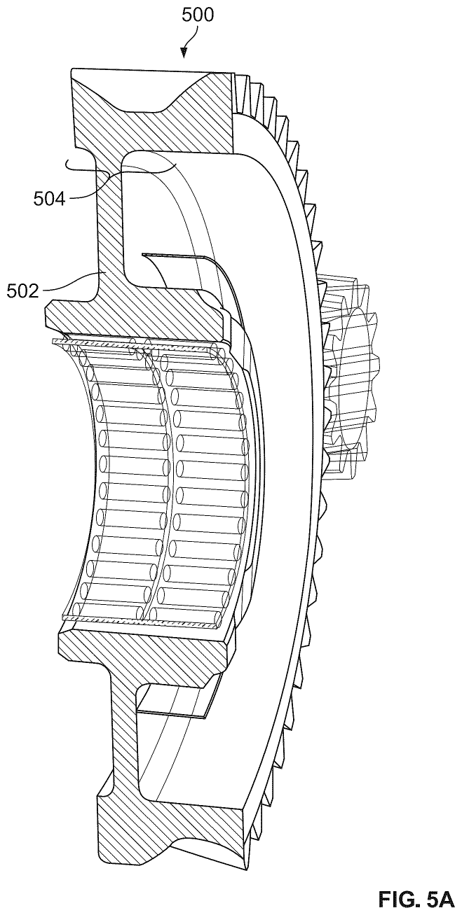

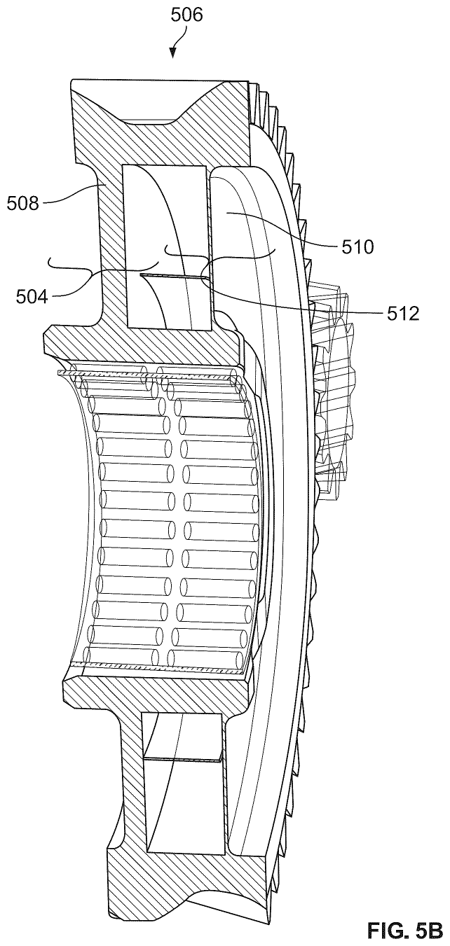

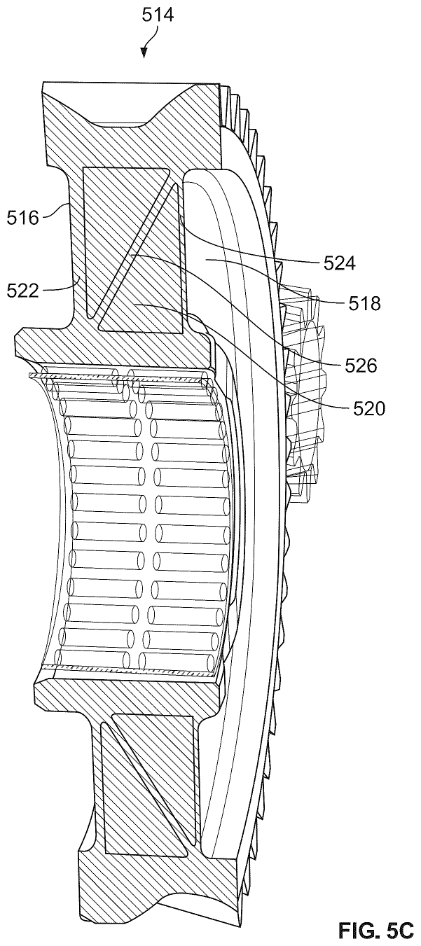

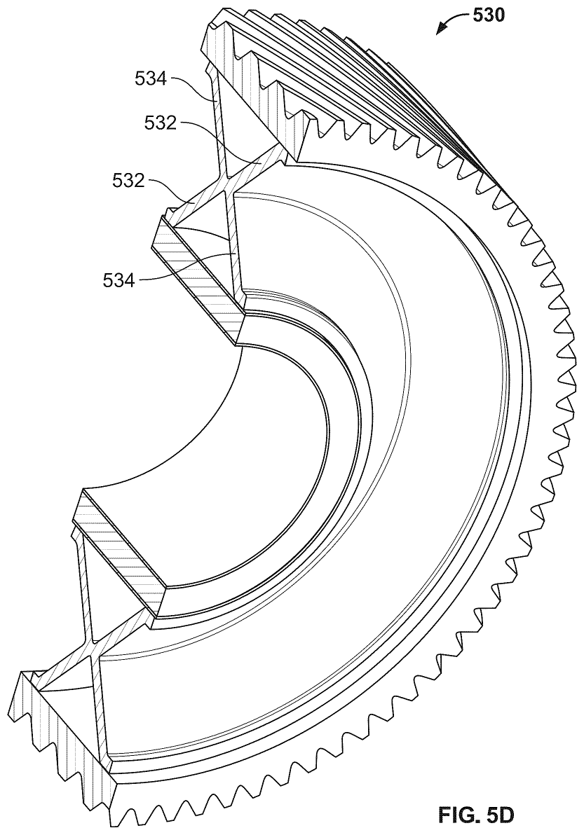

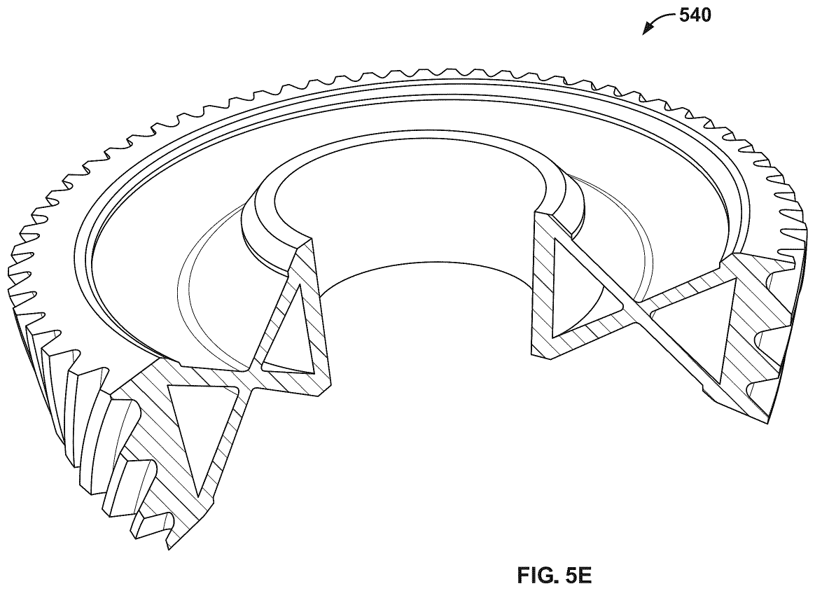

FIG. 5A depicts a single-disc design 500 of the gear assembly, according to examples of the present disclosure. In FIG. 5A, the single-disc design 500 addresses and overcomes the deficiencies of the gear assemblies having a conventional design. For example, FIG. 5A depicts a gear assembly having the single disc design 500 with a disc 502 having a thickness 504 that is lower than the thickness of conventional gear assemblies such as the gear assembly 100 depicted in FIG. 1. In various examples, the single-disc design 500 is more compliant and flexible compared to conventional disc designs. In examples, the single-disc design 500 is suitable for operations involving loads being applied in a single direction or orientation of rotation. For example, the single-disc design 500 provides a high level of flexibility as compared to conventional designs because of the geometry of the single disc 502 and the value of the thickness 504. In examples, the use of a thin disc design such as, e.g., the design of the thin disc 404 discussed above with respect to FIG. 4, and the arrangements described below and illustrated in FIGS. 5B-5D, facilitate the shifting of the natural frequencies of the gears out of critical regions. The natural frequency is obtained by dividing a stiffness of a component by the mass of the component, and taking a square root of the value from the division.

FIG. 5B depicts an example of a dual-disc design of the gear assembly of the present disclosure that addresses and overcomes the deficiencies of the gear assemblies having a conventional design. As compared to the single-disc design illustrated in FIG. 5A, the dual-disc design 506 of the gear assembly illustrated in FIG. 5B includes a first disc 508 having a thickness 504 and a second disc 510 having a thickness 512. For example, the thickness 504 in FIG. 5B may be identical to the thickness 504 of the single-disc design 500 illustrated in FIG. 5A, and the second disc 510 may have a thickness 512 that is lower than thickness 504. In various examples, an orientation of the second disc 510 is parallel to the orientation of the first disc 508. In various examples, the dual-disc design 506 provides additional advantages compared to single-disc designs in that the dual disc design 506 is better suited to enable operations involving loads that are applied in multiple directions or orientations of rotation. In another example, the first disc 508 and the second disc 510 may have the same thickness.

FIG. 5C depicts a triple-disc design 514 of the gear assembly, in accordance with various examples of the present disclosure, that addresses and overcomes the deficiencies of the gear assemblies having a conventional design. In examples, the triple disc design 514 may include a first disc element 516, a second disc element 518, and a third disc element 520. In various examples, the first disc element 516 may have a thickness 522, the second disc element 518 may have a thickness 524, and the third disc element 520 may have a thickness 526. In examples, the third disc element 520 is similar to, or has the shape of, a truncated circular cone. In an example, the triple-disc design 514 may be more rigid than conventional disc designs, but is more flexible and compliant as compared to the gear assembly having the conventional design as illustrated in FIG. 1. In other examples, the thicknesses 522, 524, 526 may be substantially similar. In examples, the thickness 524 may be marginally lower than the thicknesses 522, 526.

FIG. 5D depicts a dual cone design 530 of the gear assembly, according to various examples of the present disclosure, that addresses and overcomes the deficiencies of gear assemblies having conventional designs. In various examples, the dual-cone design 530 includes disc components 532 and 534 that are designed in a crisscrossing orientation, as illustrated in FIG. 5D. It is noted the disc components 532, 534, when configured in such an orientation, provide various advantages. For example, the dual cone design 530 enables effective operation in situations that involve loads that are applied in multiple directions or orientations of rotation. In embodiments, the dual cone design 530 is suitable to operate effectively in various electric vehicles and electrical vehicle operations. It is further noted that the crisscrossing orientation of the dual cone design 530 may have significantly more flexibility and compliance as compared to a conventional gear assembly as illustrated in FIG. 1.

In various examples, multiple gears with the dual cone design 530 may be designed and welded to the shaft as part of, e.g., a four-speed transmission. FIG. 5E depicts an example image of a machined gear assembly 540 having the example dual cone design 530 of the present disclosure. In various examples, the machined gear assembly 540 may be formed of, or include, stainless steel, or a high strength and low-alloy steel such as, e.g., ASTM A572, that offers a combination of strength, weldability, and notch rigidity. Additionally, ASTM A572 may be cost effective compared to materials conventionally used to manufacture gear assemblies. In various examples, the machined gear assembly 540 may also be formed of 1045 steel, that is made of common steel grade, but that has high strength, moderate weldability, and good impact properties. It is noted that 1045 steel is widely used in a variety of industrial applications, e.g., gears, pins, rams, shafts, sockets, rolls, axles, spindles, worms, ratchets, light gears, bolts, crankshafts, guide rods, etc. In other examples, the machined gear assembly 540 may also be formed of 8620 steel, which is a low carbon nickel chromium molybdenum alloy steel. In various examples, a gear assembly having the dual cone design 530 may be machined from a single piece of steel, in contrast to being formed from a stamping process using ASTM A572. After completion of the machining process, the ring gear and the hub may be welded to the machined steel component in order to complete the gear assembly, in accordance with other examples.

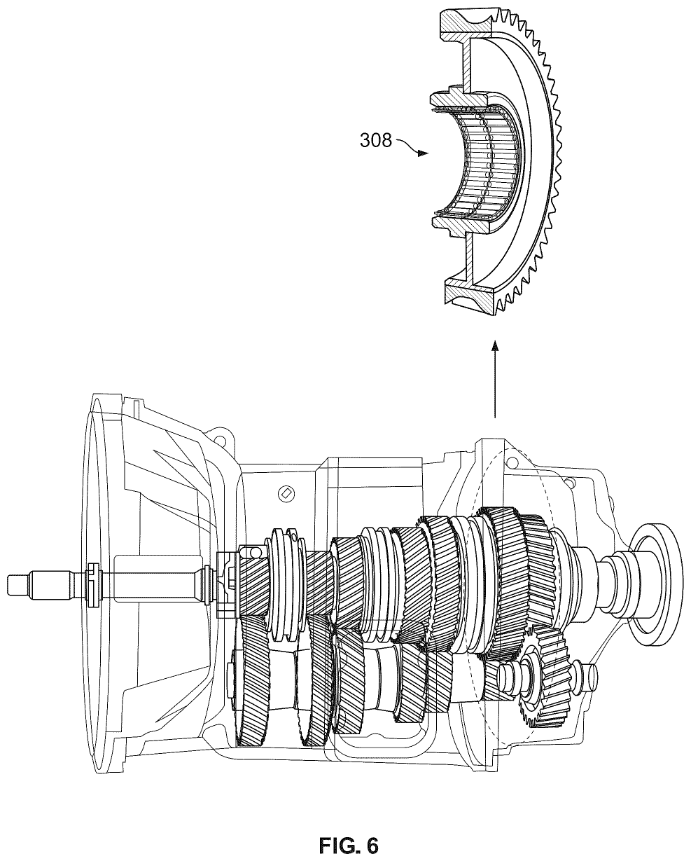

FIG. 6 depicts an example positioning of the gear assembly 300 of the present disclosure within a transmission of a vehicle. In various examples, the gear assembly 300 may have a lower mass of 3.78 kilograms as compared to a mass of 5.03 kilograms of a conventional gear assembly. As such, the gear assembly 300 has the advantage of being lighter, which enables a lighter and more efficient vehicle, as well as reduces noise during operation. In various examples, the gear assembly 300 may have superior NVH characteristics as compared to a conventional gear assembly such as, e.g., gear assembly 100 illustrated in FIG. 1.

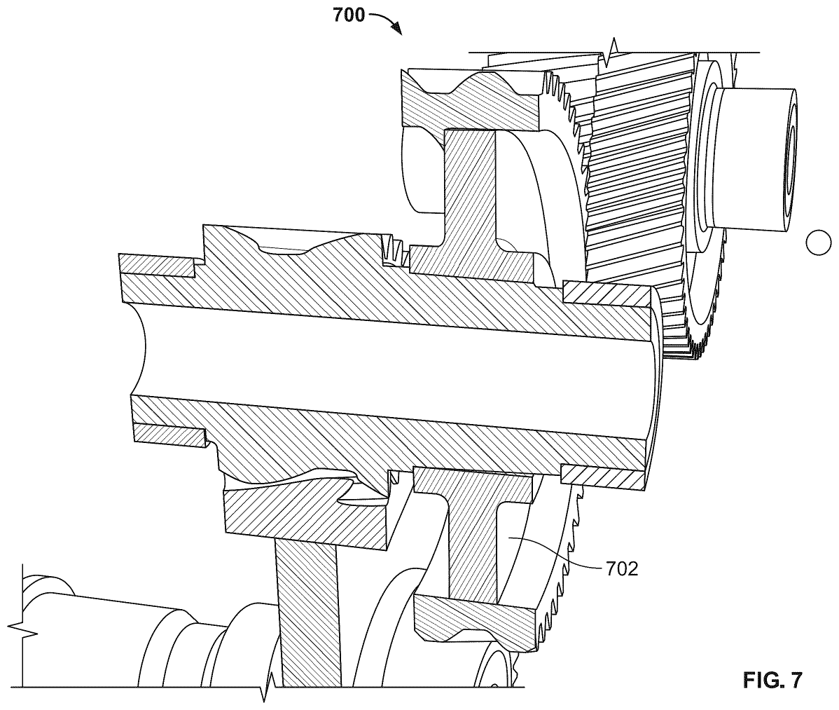

FIG. 7 depicts an example of a conventional electrical vehicle drive unit 700 in which a conventional gear assembly 702 is positioned. As illustrated, the gear assembly 702 may have a total weight of, e.g., 9.097 kilograms. In embodiments, the weight of 9.097 kilograms may be a baseline and/or average weight of gear assemblies currently in operation.

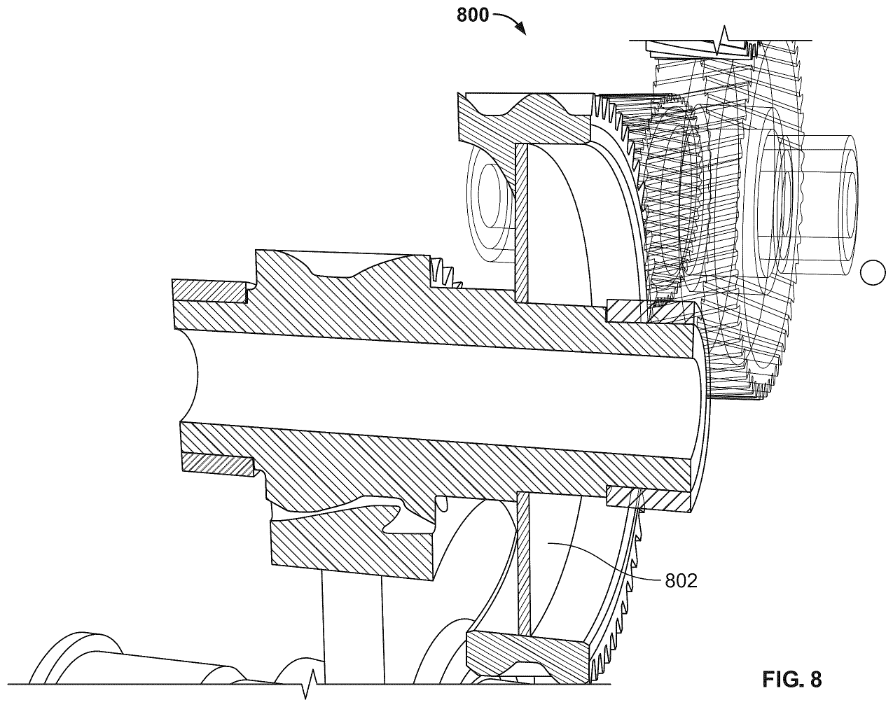

FIG. 8 depicts an example electric vehicle drive unit 800 in which an example gear assembly 802, as described in examples of the present disclosure, may be positioned. As compared to the gear assembly 702 of FIG. 7, the gear assembly illustrated in FIG. 8 may have a substantially lower total weight of, e.g., 4.945 kilograms, and such a reduced weight enables the gear assembly 802 to operate such that noise produced as a result of vibrations associated with the rotation of the gear assembly 802 is significantly lower as compared to the noise produced by the gear assembly 702.

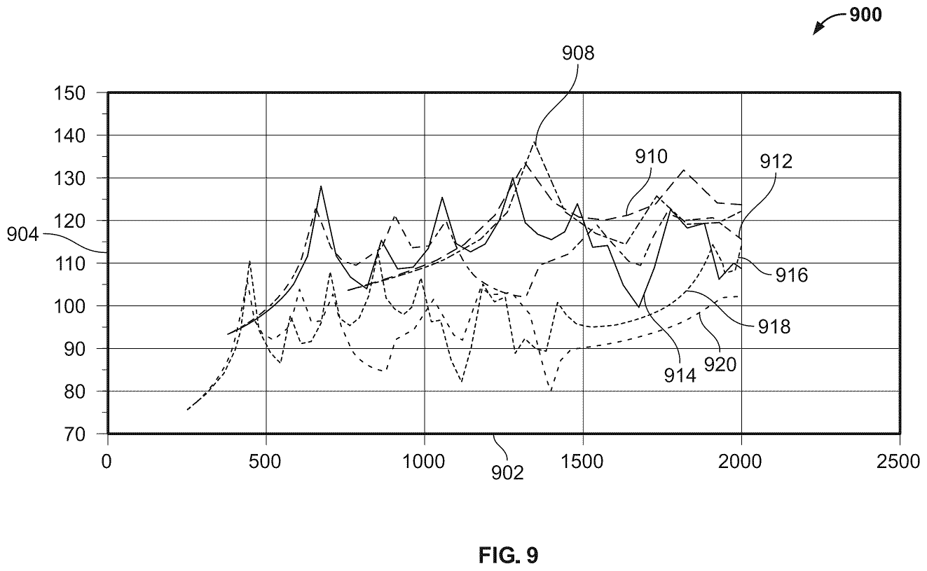

FIG. 9 depicts an example graphical representation 900 of dynamic responses of a conventional gear assembly 100 compared to dynamic responses of the gear assembly as described in examples of the present disclosure. For example, the x-axis 902 of the graphical representation 900 corresponds to rotations per minute (rpm), and the y-axis 904 corresponds to velocity values that are associated with vibrations resulting from the operation of the conventional gear assembly 100 and operation of the gear assemblies illustrated in FIGS. 5A-5E. Representation 900 includes a plot of the first harmonic 908 (1H), of the second harmonic 914 (2H), and of the third harmonic 918 (3H) of a conventional gear assembly. Representation 900 also includes a plot of the first harmonic (1H) 910, of the second harmonic 912 (2H), and of the third harmonic 920 (3H) of a gear assembly according to the various examples of this disclosure as, e.g., illustrated in FIGS. 5A-5E. In various examples, the vibration values associated with each of the harmonics 908, 914, 918 may be equal to, e.g., 139 decibels (dB), 130 dB, and 115 dB, respectively. In contrast, the vibration values associated with each of the harmonics 910, 912, 920 may be equal to, e.g., 134 dB, 123 dB, and 106 dB, respectively.

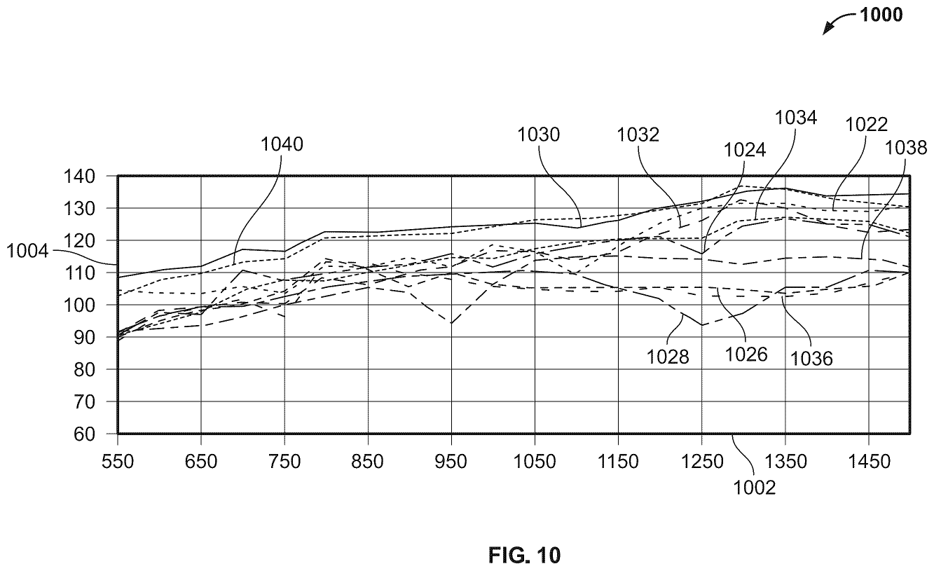

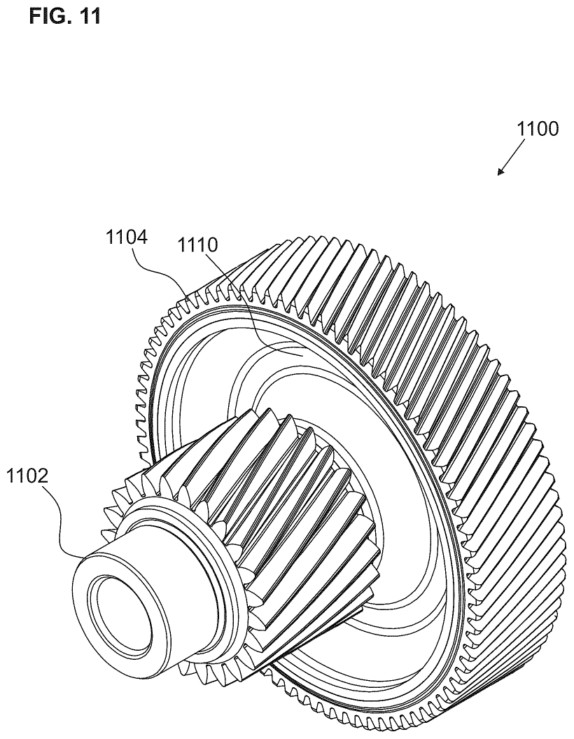

FIG. 10 depicts another example graphical representation 1000 of dynamic responses of a conventional gear assembly 100 as compared to dynamic responses of the gear assembly that were measured using an accelerometer positioned on an enclosure of each of the conventional gear assembly and the example gear assembly of the present disclosure. As illustrated, an x-axis 1002 of the graphical representation 1000 is associated with rotations per minute (rpm) and the y-axis 1004 is associated with vibrations that are measured using the accelerometer that may be disposed on an exterior portion of an enclosure in which the conventional gear assembly 100 may be disposed, and an exterior portion of the enclosure in which the gear assembly as described in the present disclosure may be disposed.

The rotational speed (represented by rpms) of each of the gears is varied from a range of approximately 550 rpms to 1500 rpms, and the vibration data of each of the gear assemblies over this range is measured and illustrated in FIG. 10. In examples, lines 1022, 1024, 1026, 1028, and 1030 correspond to the vibrations values of the conventional gear assembly 100 in each of the first harmonic, the second harmonic, the third harmonic, a fourth harmonic, and a harmonic order sum, traced over approximately 550 rpms to 1500 rpms. In contrast, lines 1032, 1034, 1036, 1038, and 1040 correspond to the vibration values of the example gear assembly of the present disclosure, as illustrated in FIGS. 5A-5B, traced over a range of approximately 550 rpms to 1500 rpms.

Additionally, the plotted lines 1032, 1034, 1036, 1038, and 1040 correspond to the vibration values of the gear assembly as described in the present disclosure in each of the first harmonic, the second harmonic, the third harmonic, the fourth harmonic, and the harmonic order sum. As illustrated, the vibration values associated with the gear assembly of the present disclosure, when in operation, are lower as compared to the vibrations associated with the conventional gear assembly 100. Specifically, the vibration values across all harmonics are lower by approximately 1 dB to 2 dB.

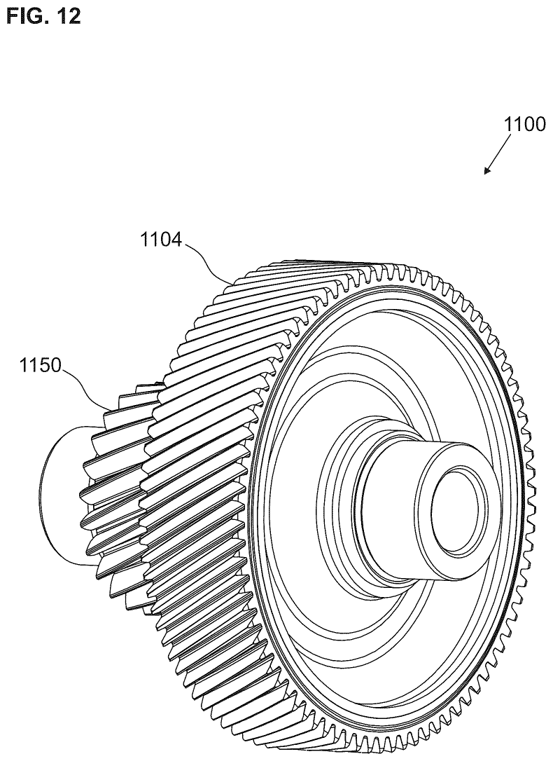

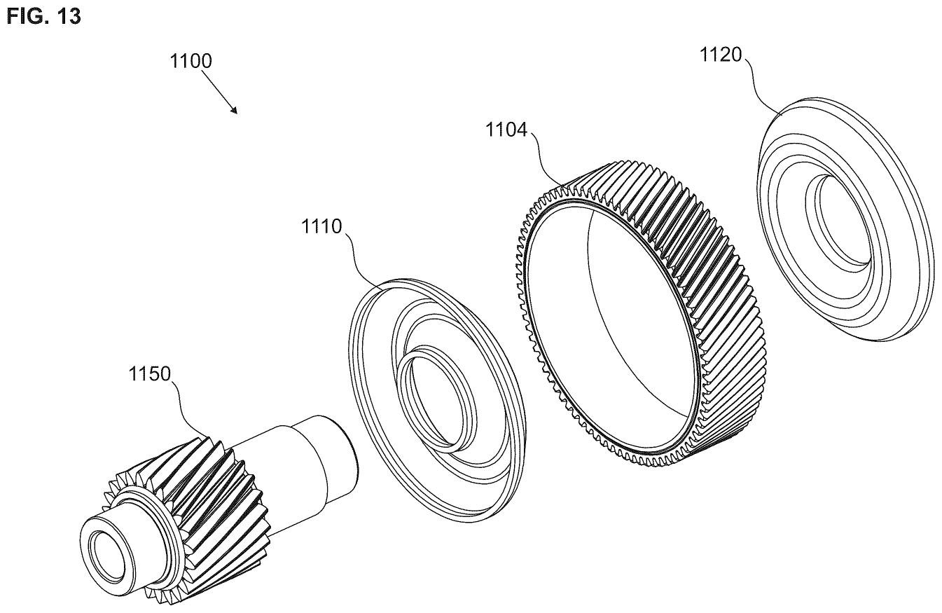

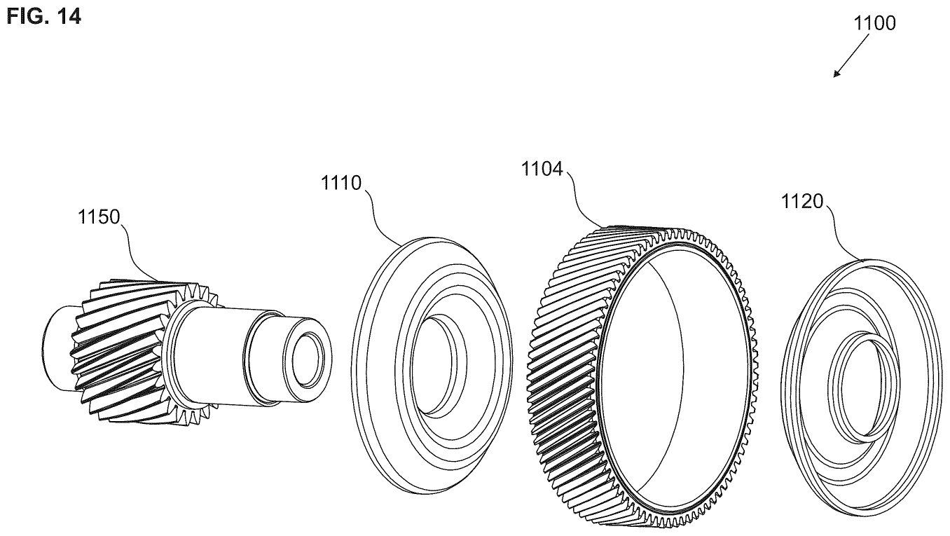

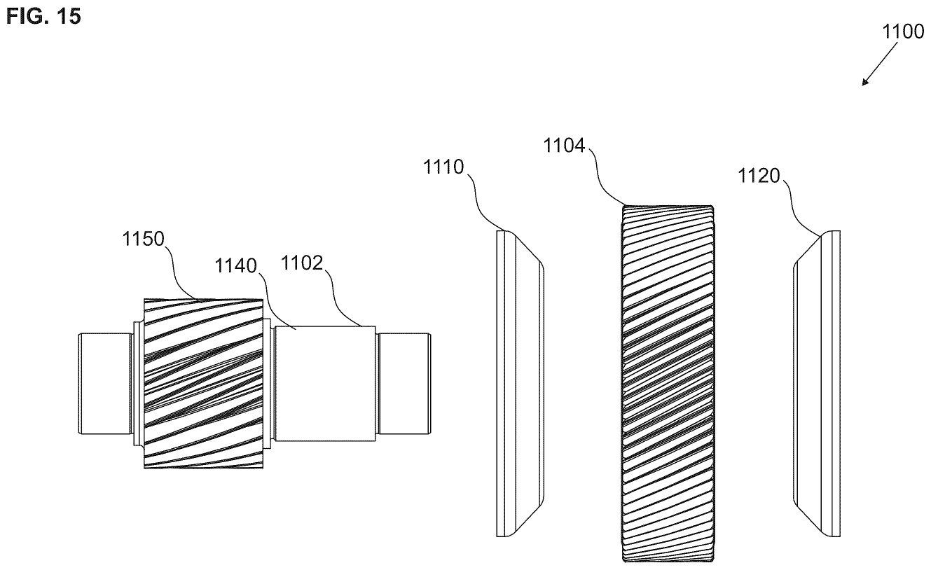

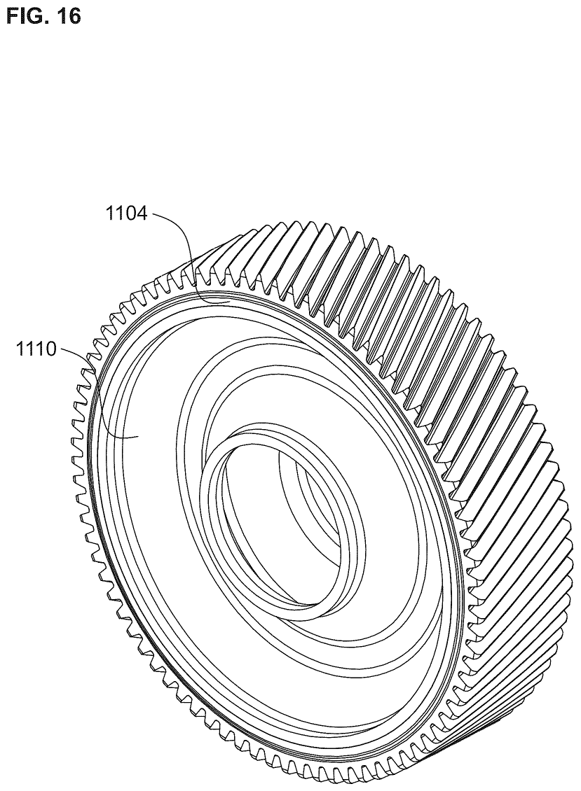

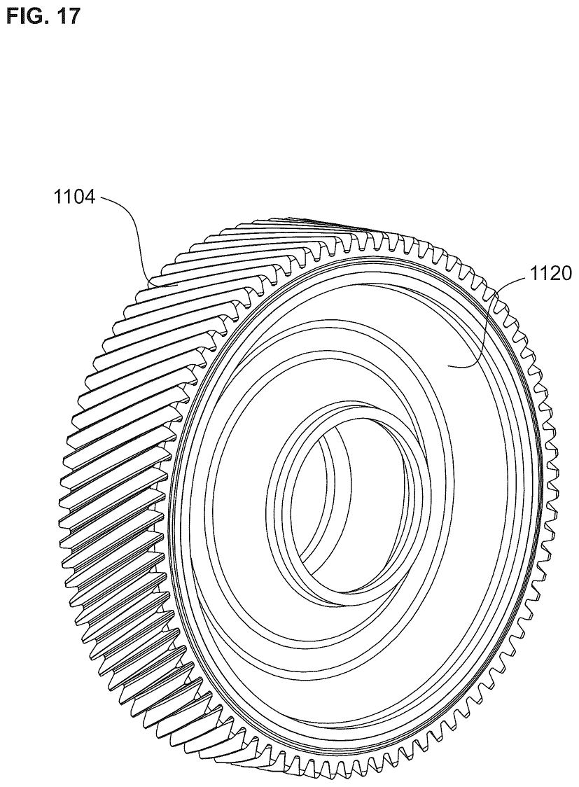

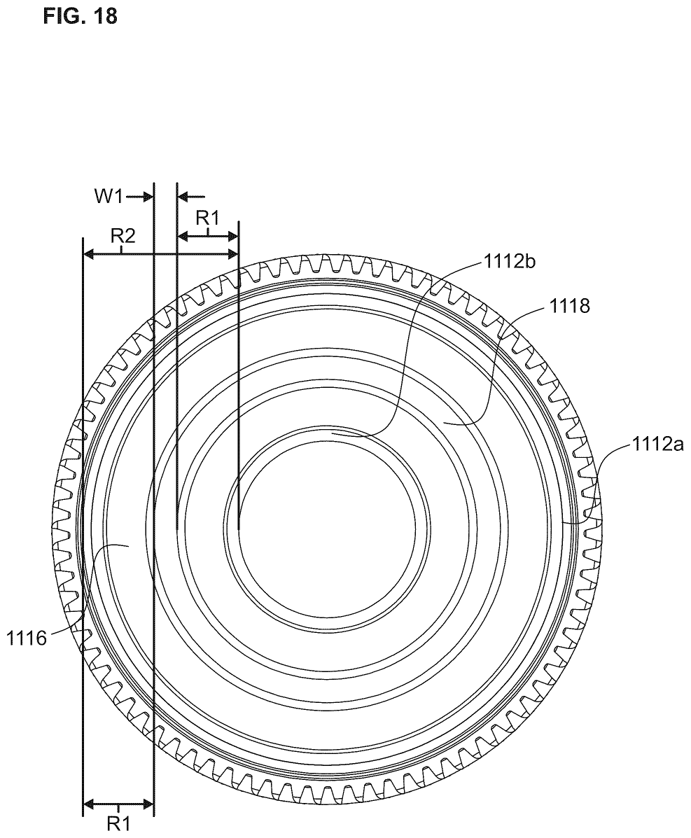

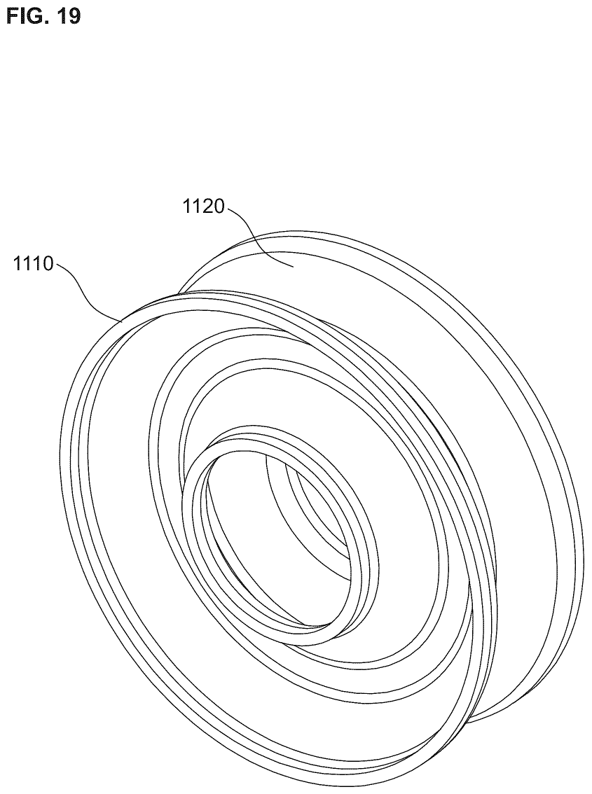

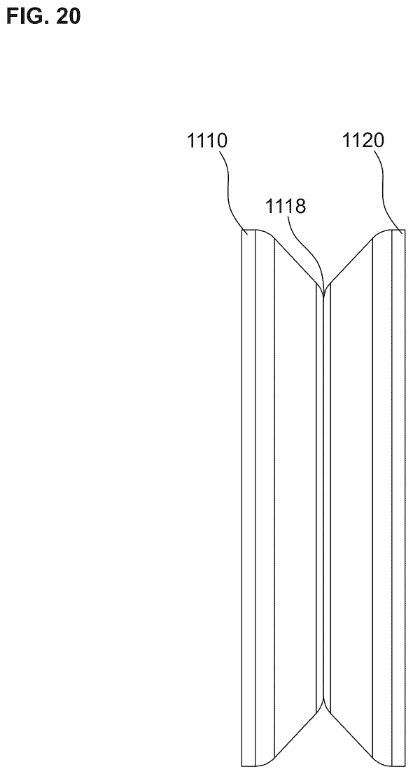

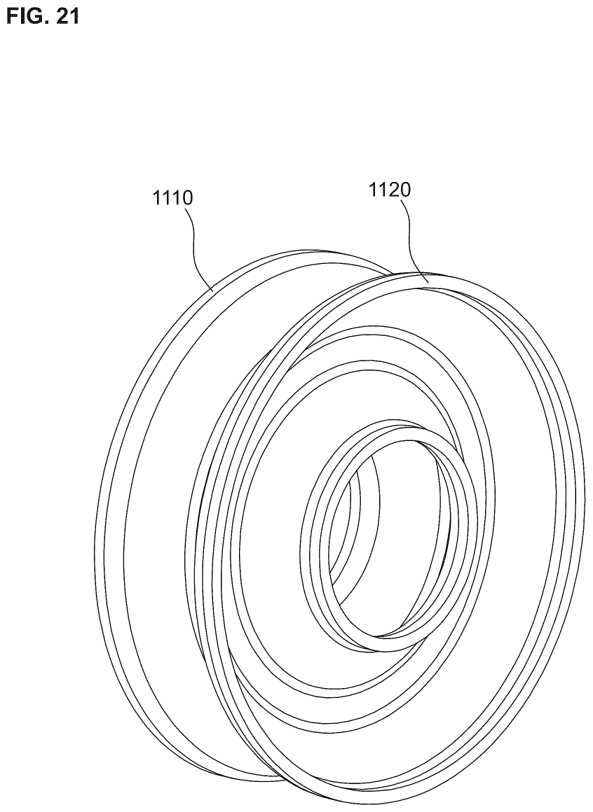

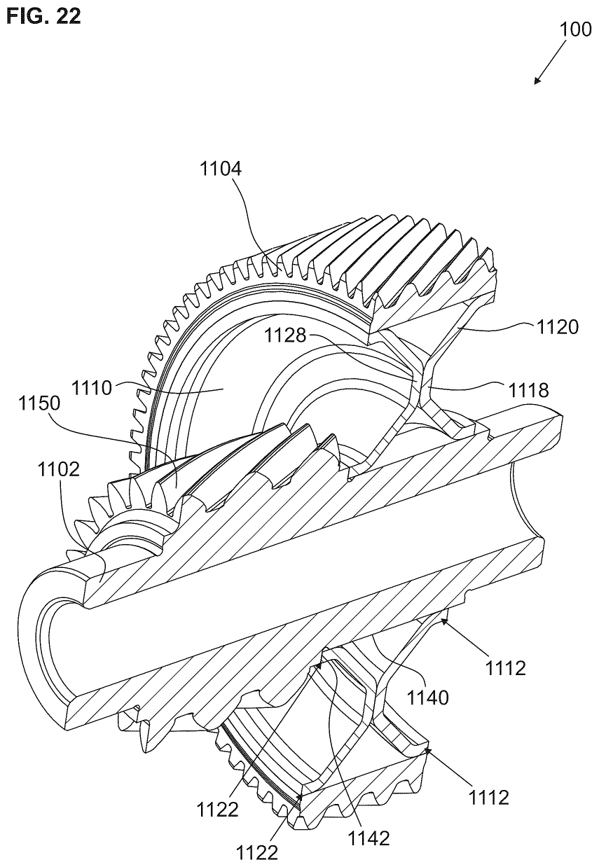

### Examples of FIGS. 11-27

FIGS. 11-23 depicts an example gear and shaft assembly 1100. Referring to FIGS. 11-18, the gear and shaft assembly 1100 includes a shaft 1102, and ring gear 1104 and a dual disc assembly 1106. The disc assembly 1106 and gear 1104 may be referred to as a gear assembly or gear arrangement. The shaft 1102 including an axis A1 extending along the length of the shaft. The dual disc assembly 1106 including a first disc component 1110 and a second disc component 1120. The first and second disc components 1110, 1120 can be discs that have a generally C-shaped cross-section. In some examples, and as shown in FIGS. 11-23, the first and second disc components 1110, 1120 are identical to each other and adjoined along a plane or axis extending orthogonally to the longitudinal axis A1. Other arrangements are possible. For example, the first disc component 1110 can have a different shape in comparison to the second disc component 1120.

Referring to FIG. 16-23, the first disc component 1110 may include a first end 1114 with an axially extending segment 1112a abutting and extending along an interior surface of the gear 1104, and a second end 1116 with an axially extending segment 1112b abutting and extending along an exterior surface of the shaft 1102, and a radially extending intermediate portion 1118. The first disc component 1110 is further shown as including angled portions 1115, 1117 joining the intermediate portion 1118 to the segments 1112a, 1112b such that the angled portions 1115, 1117, 1118 form an axially extending recess or cavity. The angled portions are shown as being angled at an oblique angle relative to axial lengths of the ring gear and/or shaft. The angled portions may be straight or curved or formed by a combination of straight and curved portions. Taken together, the segments 1112a, 1112b and portions 1118, 1115, 1117 can be characterized as being generally forming a C-shape

The second disc component 1120 may similarly include a first end 1124 with an axially extending segment 1122a abutting and extending along the interior surface of the gear 1104, and a second end 1126 with an axially extending segment 1122b abutting and extending along the exterior surface of the shaft 1102, and a radially extending intermediate portion 1128. The second disc component 1120 is further shown as including angled portions 1125, 1127 joining the intermediate portion 1128 to the segments 1122a, 1122b.

In one aspect, the intermediate portion 1118 of the first disc 1110 and the intermediate portion 1128 of the second disc 1120 may be joined along the radially length. When so joined, the first and second disc components 1110,1120 are mirrored from each other across an axis A2 which extends through the shaft and ring gear. The first and second ends 1114, 1116 of the first disc component 1110 extending in first direction along the shaft 1102. The first and second ends 1124, 1126 of the second disc component 1120 extending in a second direction along the shaft 1102. In some examples, the intermediate portions 1118, 1128 may be joined via welding. Other joining processes are possible, such as by mechanical fastening means, adhesives, etc. The axially extending segments 1112, 1122 at the first and second ends of each of the first and second discs 1110, 1120 can have respective lengths L1, L2 which are equal. In some examples, the axially extending segments 1112, 1122 at the first ends 1114, 1124 are longer than the axially extending segments 1112 at the second ends 1116, 1126 of each disc. In other examples, the axially extending segments 1112, 1122 at the second ends 1116, 1126 are longer than the axial extending segments 1112 at the first ends 1114,1124 of each disc component 1110, 1120.

In one aspect, the shaft 1102 may be configured with an outer surface 1140 extending to an integrally formed or attached gear portion 1150 defining a plurality of teeth. In the particular example shown, the shaft 1102 includes a shoulder 1142 presenting an axial face at the interface between the outer surface 1140 and the gear portion 1150. When the first and second disc components 1110, 1120 are arranged on the shaft 1102, the axially extending segments 1112b, and 1122b abut against the outer radial surface 1140 of the shaft 1102 such that the segment 122b abuts the shoulder 1142. In one aspect, the shoulder 1142 acts as an axial stop for the second disc components 1120 and for the overall assembly of the disc components 1110, 1120 and the gear 1104. When so arranged, the first and/or second disc components 1110, 1120 may be welded or otherwise joined to the shaft 1102.

The second ends of the respective first and second disc components 1110, 1120 extending from the intermediate portion 1118 to an inner surface of the axial extending surface contacting the shaft may have a radial length R1. In some instances, the first ends and second ends may have the radial length R1. In other examples, the first ends may have a radial length longer than R1. The intermediate portion 1118 may have a width W1. The width W1 may be shorter than the radial length R1. The disc components 1110, and 1120 may have a radial length R2.

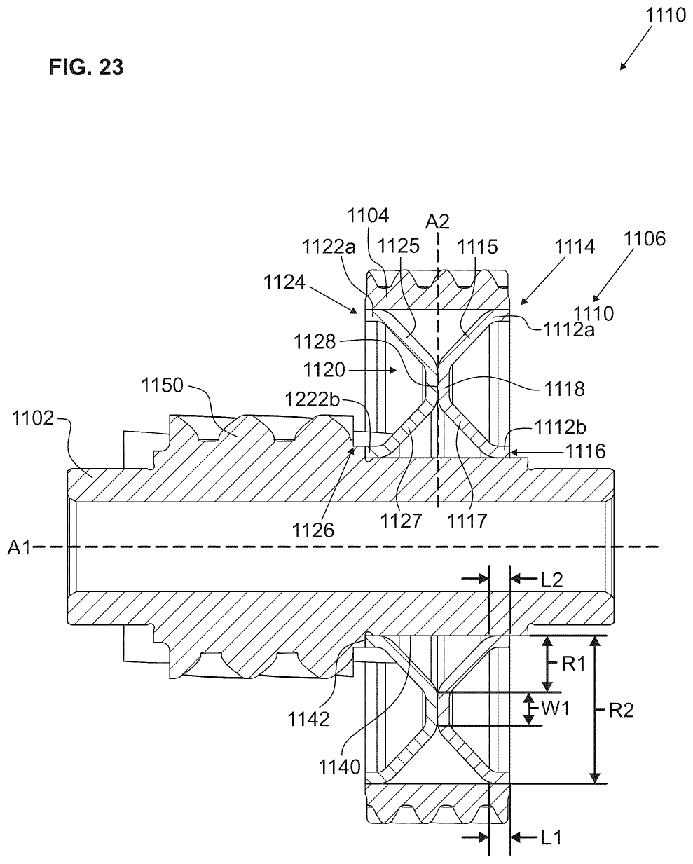

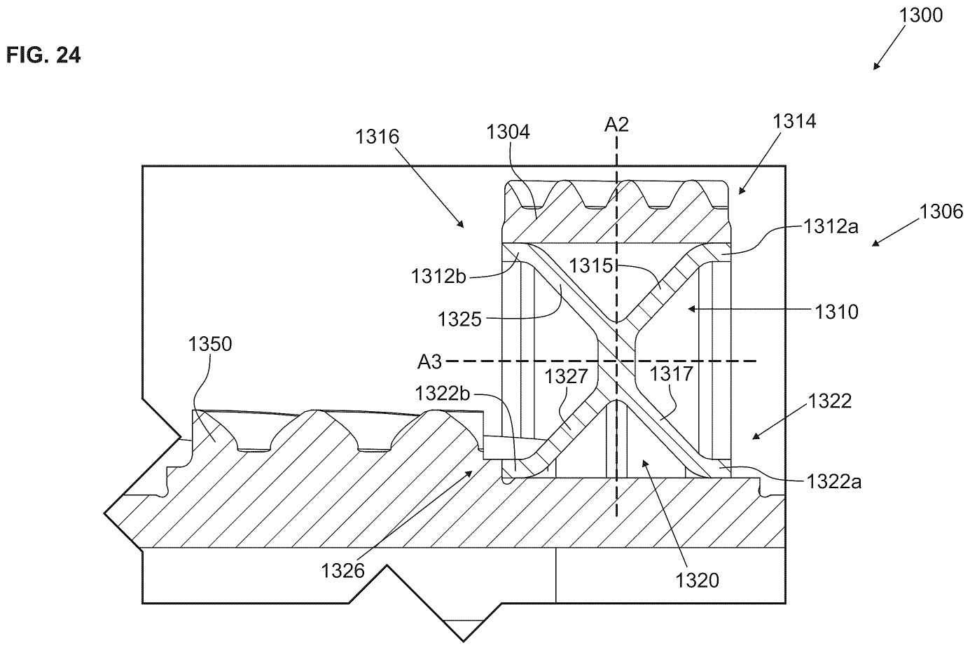

Referring to FIGS. 24-27, alternative configurations are presented with dual disc assemblies in which inner and outer disc portions are joined along an axial interface rather than being laterally abutting disc portions joined along a radial interface. As shown, a gear and shaft assembly 1300 includes a shaft 1302, and ring gear 1304 and the dual disc assembly 1306. The shaft 1302 includes a toothed region 1350. The dual disc assembly 1306 including a first disc 1310 component and a second disc component 1320. The first disc component 1310 including a first end 1314 and a second end 1316 joined directly to the shaft 1302 such as by welding. The second disc component 1320 including first and second ends 1324, 1326 joined directly to the ring gear 1304 such as by welding. The ends 1324, 1326 of both the first and second disc components 1310, 1320 come together to form a V-shape or a Y shape. The first and second components each have an intermediate portion 1318. In the example dual disc assembly, the first and second disc 1310, 1320 are mirrored relative to each other across an axis A3, parallel to the axis A1 (shown in FIG. 23) of the shaft. The first and second ends 1314, 1316 of the first disc component 1310 extending in first direction toward the ring gear. The first and second ends 1324, 1326 of the second disc component 1320 extending in a second direction toward the shaft. In some examples, the ends of the first disc component 1310 may instead extend toward the shaft and the ends of the second disc component 1320 may extend toward the ring gear 1304. The intermediate portions of each may be welded together along a longitudinal axis A2. The first disc component 1310 includes axial extending surfaces 1312a and 1312b. The second disc component 1320 includes axial extending surfaces 1322a and 1322b. Surfaces 1312a are defined by the first end 1314 of the first disc component 1310 and the surface 1312b is defined by the second end 1316. Surfaces 1322a are defined by the first end 1324 of the second disc components 1320 and the surface 1322b is defined by the second end 1326. The axial surfaces 1312, 1322 are welded to respective ring gear 1304 or shaft 1302.

The first ends 1314 may have an angled portion 1315 between the intermediate portion and the axial extending surface 1312a. The second ends 1316 may have an angled portion 1317 between the axial extending surfaces 1312b. The first and second ends 1324, 1326 have angled portions 1325 and 1327 between the surfaces 1322a, 1322b. The angled portions 1315, 1317, 1325, 1327 are angled relative to axial lengths of the ring gear 1304 and/or shaft 1302. The first and second disc components 1310, 1320 can be welded together at intermediate portions 1318, 1328.

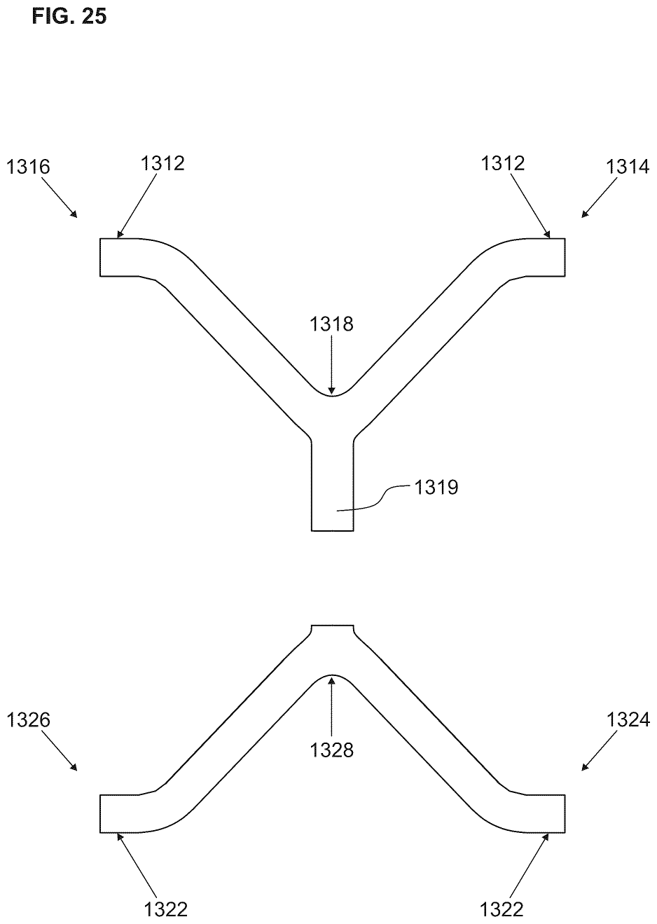

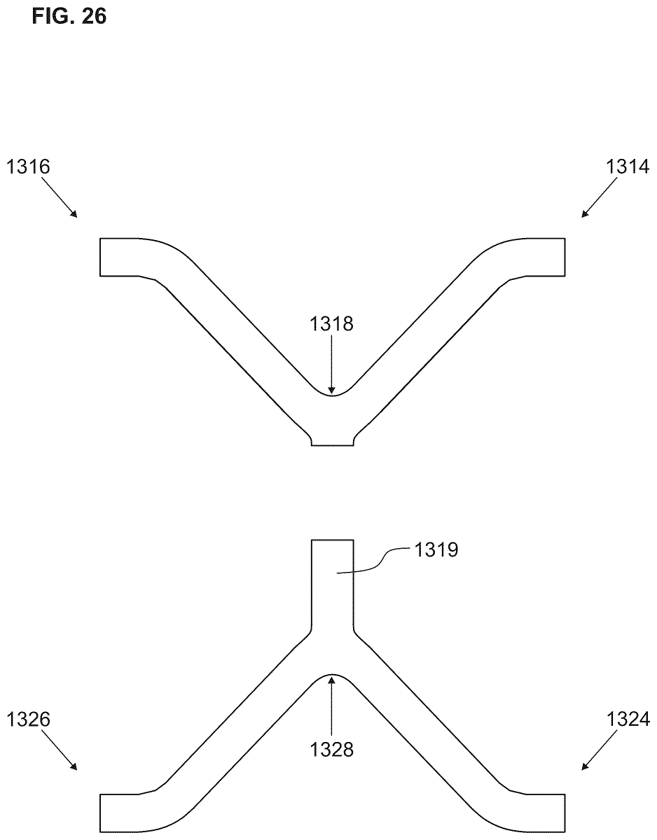

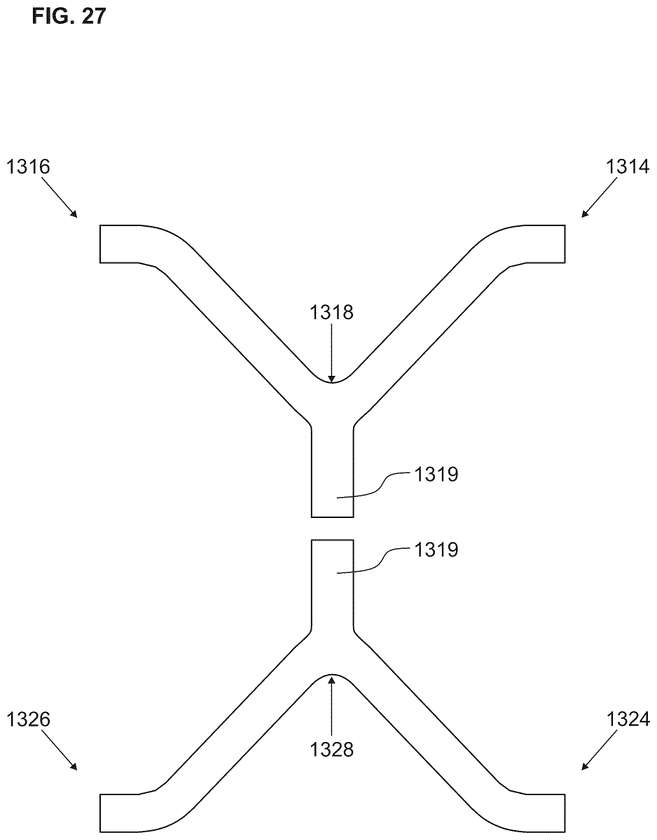

In some instances, the intermediate portions 1318, 1328 of the first and/or second disc components 1310, 1320 can include a longitudinal surface 1319 extending beyond the intermediate portion 1318, 1328. The longitudinal surface 1319 can include a first end 1314 joined to the intermediate portion 1318 and the second end 1316 weldable to the other of the first or second disc components 1310, 1320. In some instances, only the first disc component 1310 include the longitudinal surface 1319 (shown in FIG. 25) and the second disc component 1320 does not include a longitudinal surface 1319. The longitudinal surface 1319 of the first disc component 1310 may join with the intermediate portion 1318 of the second disc component 1320. In some instances, only the second disc component 1320 include the longitudinal surface 1319 (shown in FIG. 26) and the first disc component 1310 does not include a longitudinal surface 1319. The longitudinal surface 1319 of the second disc component 1320 may join with the intermediate portion 1318 of the first disc component 1310. In some instances, both the first disc component 1310 and second disc component 1320 include the longitudinal surfaces and the longitudinal surface 1319 are welded together to form the dual disc assembly (shown in FIG. 27). The first and second ends 1314, 1316 including an axial extending surfaces 1312, 1322 at each end of respective first and second disc components 1310, 1320.

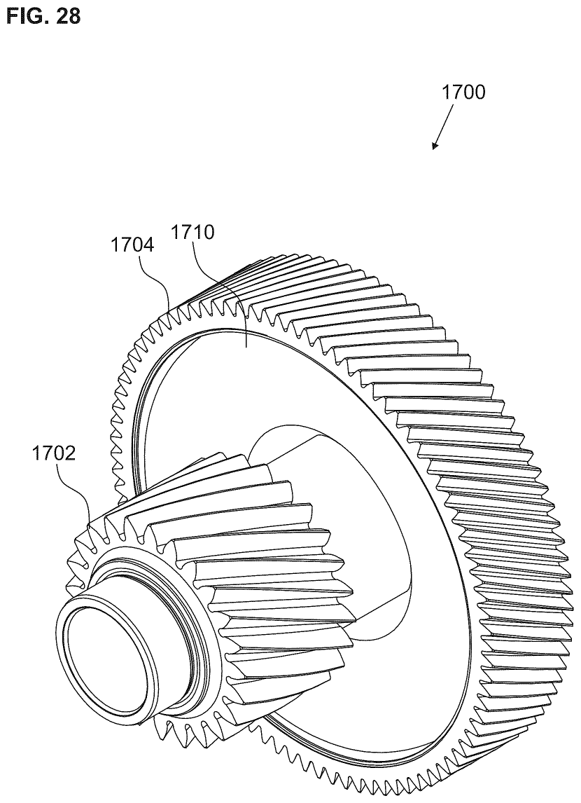

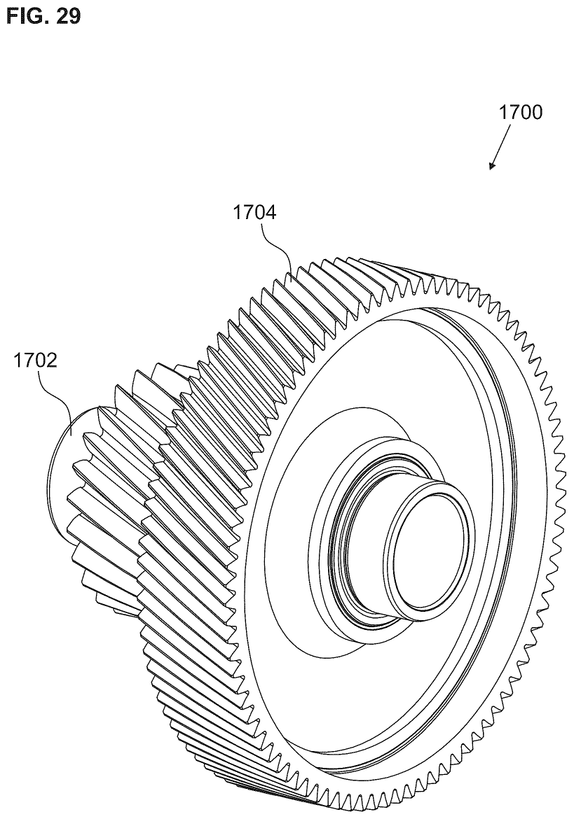

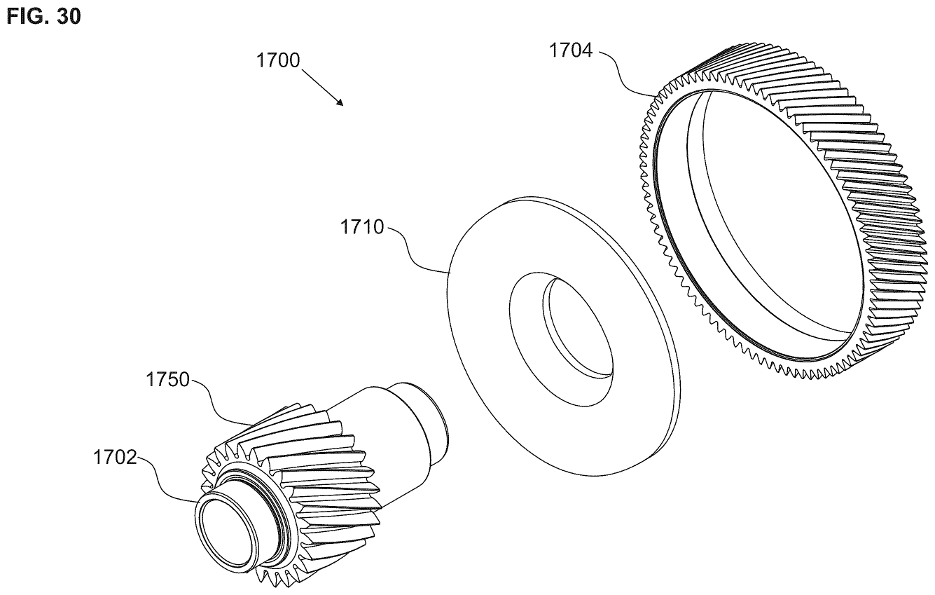

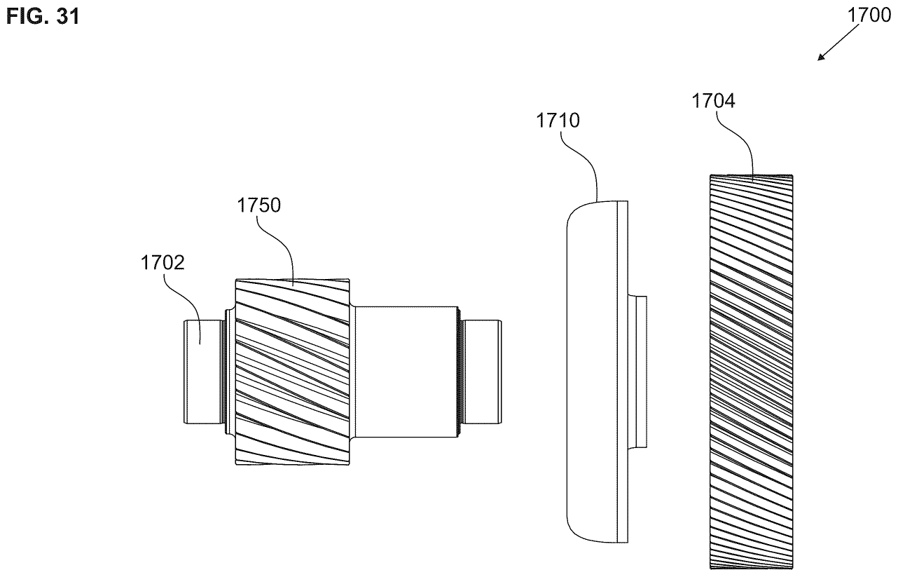

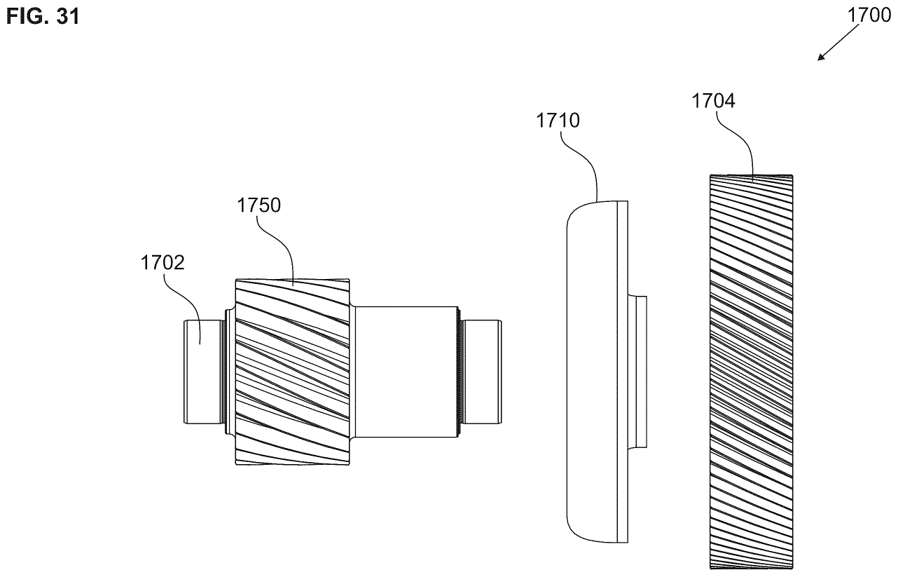

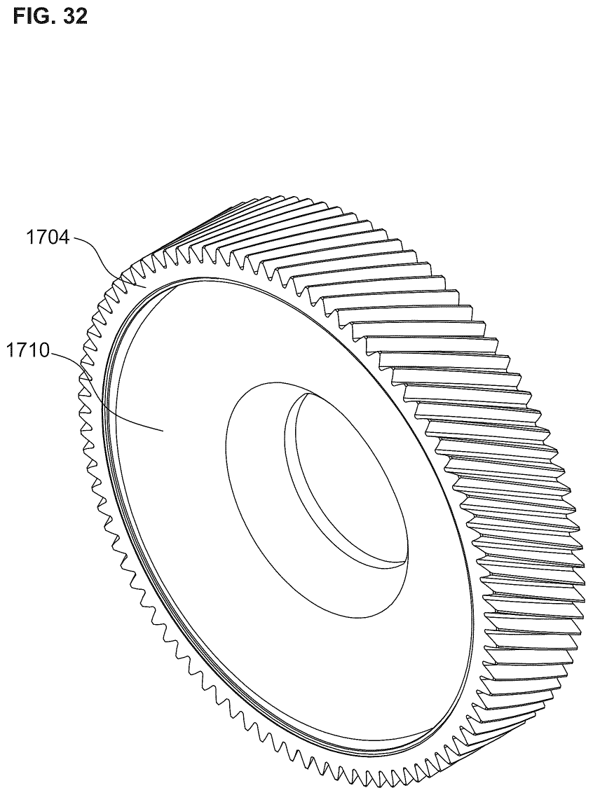

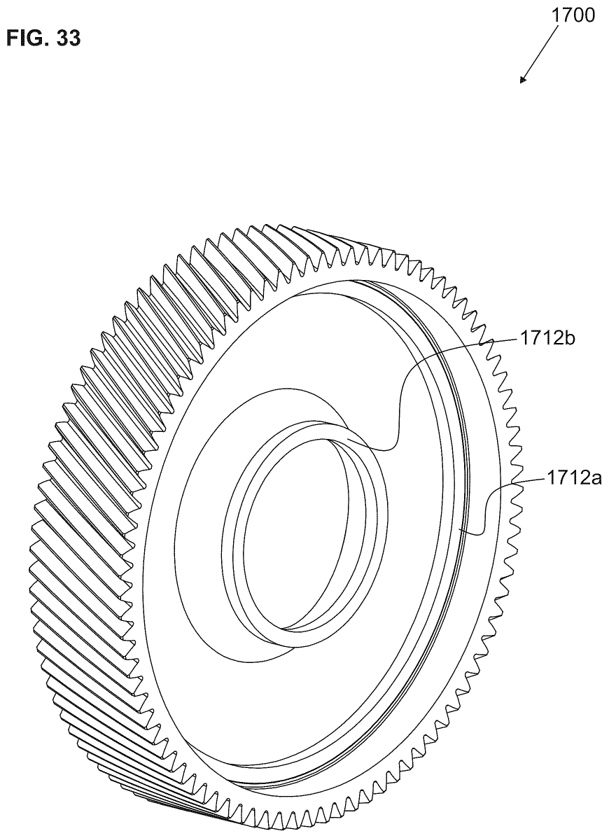

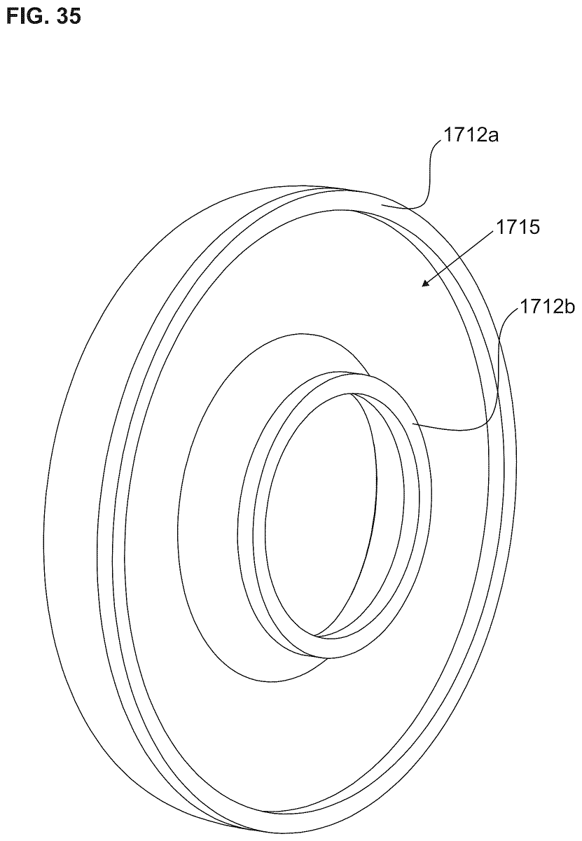

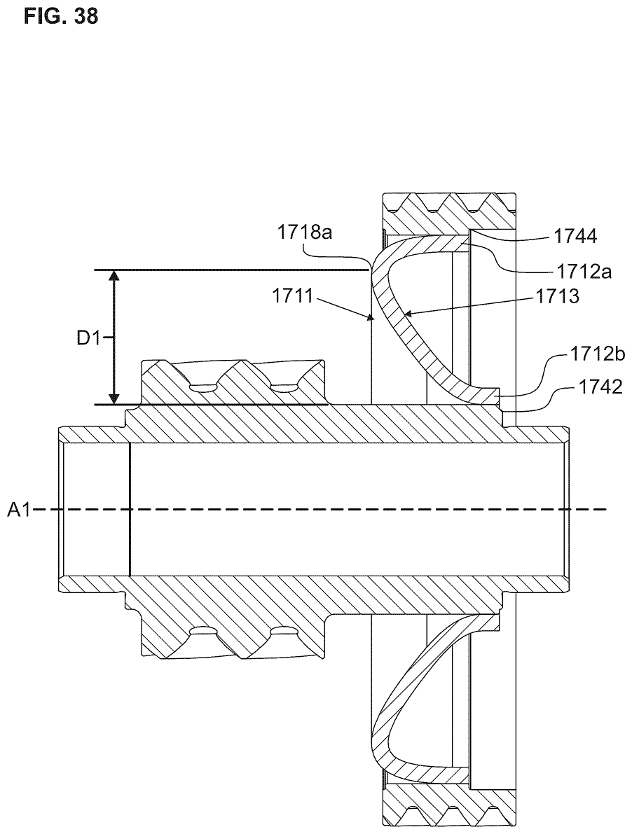

### Example of FIGS. 28-41

FIGS. 28-41 depicts a further example gear and shaft assembly 1700. As shown, the shaft assembly 1700 includes a shaft 1702, a ring gear, 1704, and a single disc 1710 forming a generally C-shaped cross-sectional profile. Referring to FIGS. 28-35, the disc 1710 is shown as being joined directly to the shaft 1702. The shaft 1702 includes a toothed region 1750. The disc 1710 includes a first side 1711 and a second side 1713 opposite the first side 1711. The first and second side 1711, 1713 extending from a first end 1714 to a second end 1716. The first end 1714 joinable to the ring gear 1704, and the second end 1716 joinable to the shaft 1702. The first side 1711 of the first end 1714 is joined to the ring gear 1704, and the first side 1711 of the second end 1716 is joined to the shaft 1702. In some examples, the first side 1711 of the first end 1714 is joined to the ring gear 1704, and the first side 1711 is joined to the shaft 1702. The second side 1713 at the first end 1714 is faces radially inward and away from the ring gear and the second side 1713 at the second end 1716 faces radially inward and away from the shaft 1102. The disc 1710 includes an intermediate portion 1718. In the example disc 1710, the intermediate portion 1718 is a curved length extending between the first and second ends 1714, 1716. The first and second ends 1714, 1716 extend away from the intermediate portion 1718 in a first direction along the shaft. It should be understood that the body is a single piece construction. The disc 1710 forms an axially extending recess or cavity 1715 between the first and second ends 1714, 1716. The disc 1710 may be either solid or apertured.

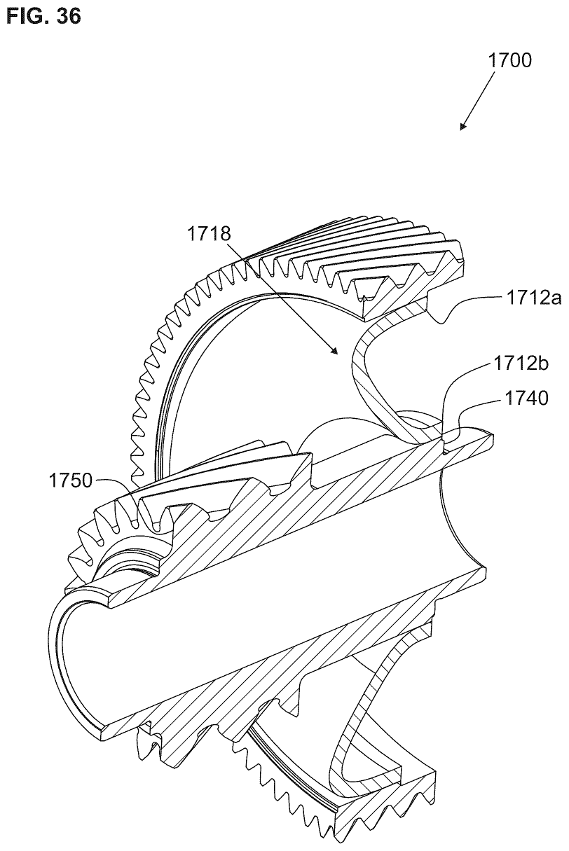

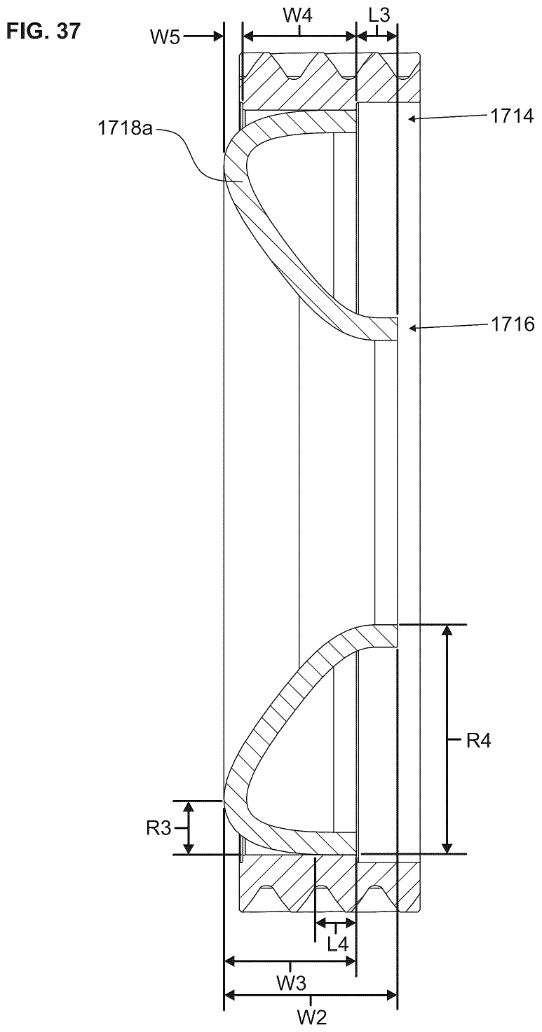

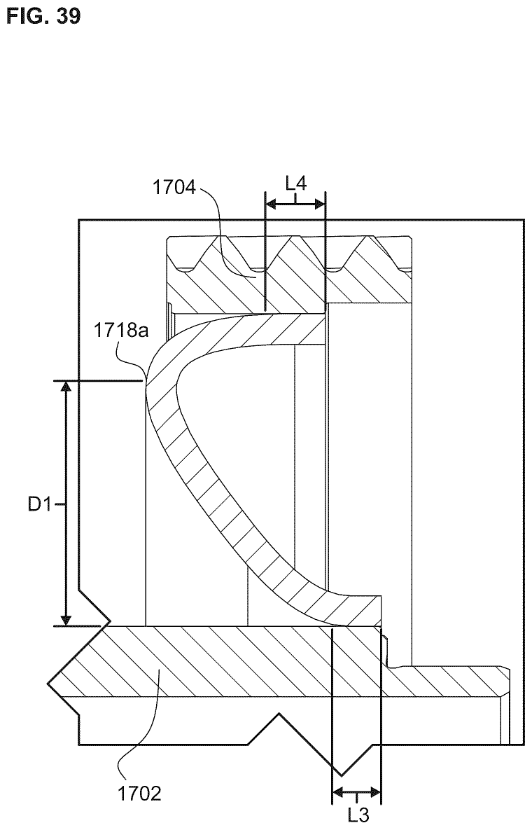

Referring to FIGS. 36-38, the first end 1714 may include an axially extending surface 1712a along the ring gear 1704. The ring gear 1704 may include a shoulder 1744 and the axially extending surface 1712a may align with the shoulder 1744 The second end 1716 may include an axially extending surface 1712b. The axially extending surface 1712b of the first end 1714 extends along the shaft 1702 and aligns with a shoulder 1740 of the shaft 1702. The distal ends of axially extending surfaces 1712a, 1712b of the first and second ends 1714, 1716 are at least partially offset in an axial direction along the longitudinal axis A1 of the shaft. In other examples, the distal ends of the first and second axial surfaces may be aligned such that the first and second ends 1714, 1716 are axially aligned. The axially extending surfaces 1712 may be the same or different lengths. The axial extending surface 1712b may a length L3 (shown in FIG. 39) which is longer than a length L4 (shown in FIG. 39) of the axial extending surface 1712a. The disc component 1710 may have a width W2 from the axial extending surface 1712a to the apex 1718a, and a width W3 (shown in FIG. 37) from the axial extending surface 1712b to the apex 1718a. The width W2 may be longer than the width W3. Additionally, an end of the ring gear to the shoulder may be a width W4. The apex 1718a may project outside the width of the ring gear 104 and/or end of the ring gear at a width W5. Further, the axially extending surfaces may include the same widths or different widths. The recess or cavity 1715 is defined between the axially extending surfaces of the first and second ends 1714, 1716. In some examples, the disc 1710 may have a varying thickness or a constant thickness.

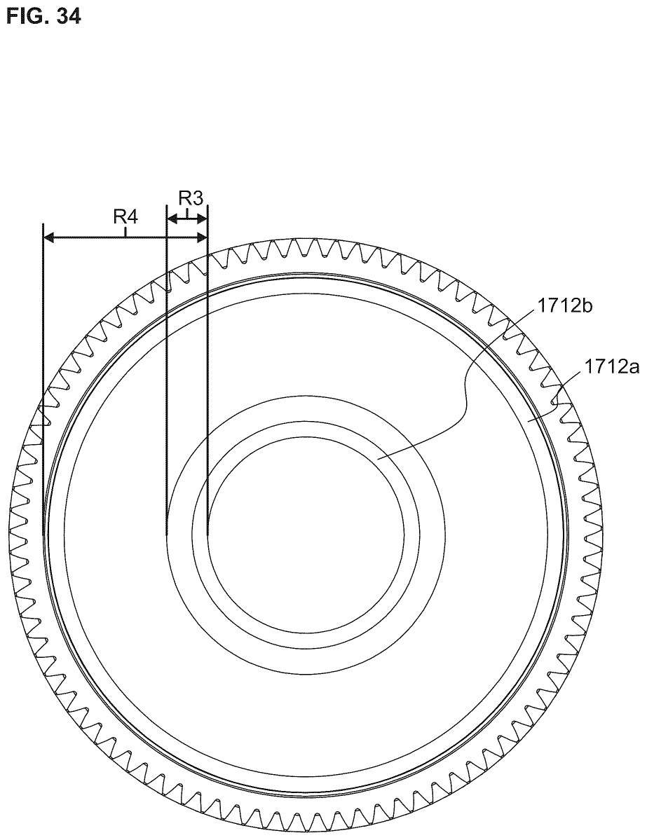

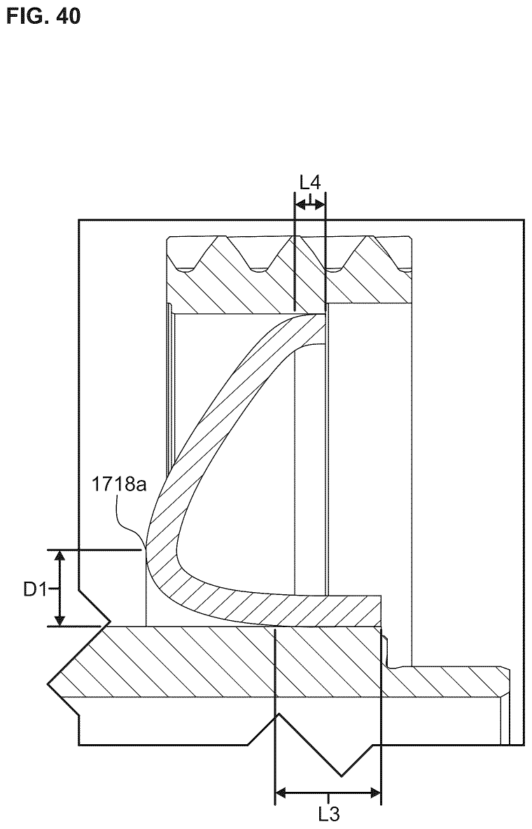

Referring to FIGS. 34, 37, and 39, an apex 1718a of the curved disc component is positioned offset from a midpoint between the ring gear and the shaft. In some examples, the apex 1718a of the curve of the disc 1710 is positioned adjacent and closer to the ring gear 1704 than the shaft 1702. In some examples, the apex 1718a of the curve of the disc 1710 is positioned adjacent and closer to the shaft 1702 than ring gear 1704 (shown in FIG. 40). The second ends of the first component 1710 extending from the apex 1718a of intermediate portion to an inner surface of the axial extending surface contacting the shaft may have a radial length R3 (shown in FIG. 34). In some instances, the first ends and second ends may have the radial length R3. In other examples, the first end may have a radial length longer than R3. The disc component 1710 may have a radial length R4(shown in FIG. 34) from the axial extending surface 1712b contacting the shaft to the axial extending surface 1712a contacting the ring gear.

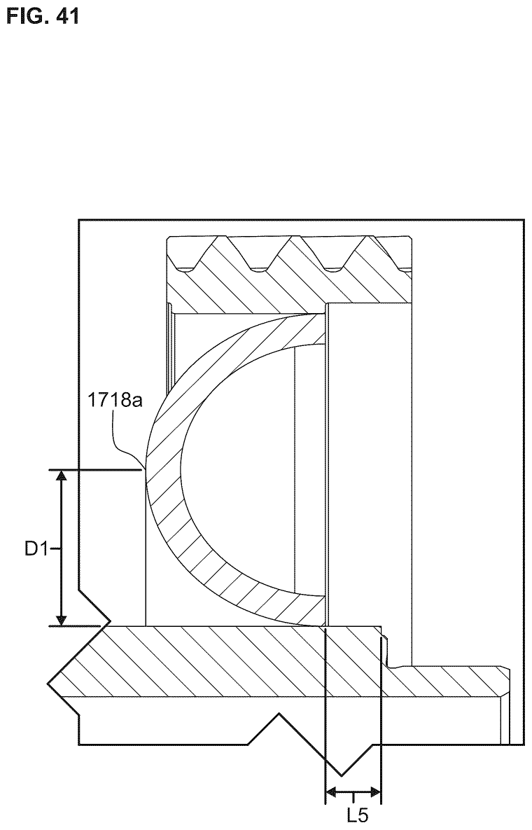

Referring to FIG. 41, in other examples, the disc 1710 is symmetrically curved such that the distance of the apex 1718a from the intermediate portion 1718 to the shaft 1702 and gear 1704 are equidistant. When the disc is symmetrical, the length of the axial extending surfaces have an equal length, and the axial extending surface 1712a may not extend to the should 1740. Instead, a length L5 may be defined between the shoulder and an end of surface 1712b. In other examples, the intermediate portion 1718 may be an interface between the linear lengths of the first and second ends 1714, 1716 which come to a point in a V-shape. In other examples, disc 1710 have multiple curved sections (i.e., the first end 1714 and the second end 1716) instead of just one large curve such that the disc forms a W-shape.

In some examples, the shoulder 1740 of the shaft can include a relief 1742 aligned with an end of the axial extending surface 1712b. The surface 1712b which extends adjacent to an axial surface of the shoulder 1740 may be welded to the relief 1742. In other examples, the disc 1710 may not include a relief 1742. The ring gear 1704 may include a shoulder 1744 and a relief. The axial extending surface 1712a of the disc 1710 can be welded to the relief. In some examples, only one of the reliefs may be provided. In other examples, neither relief is provided.

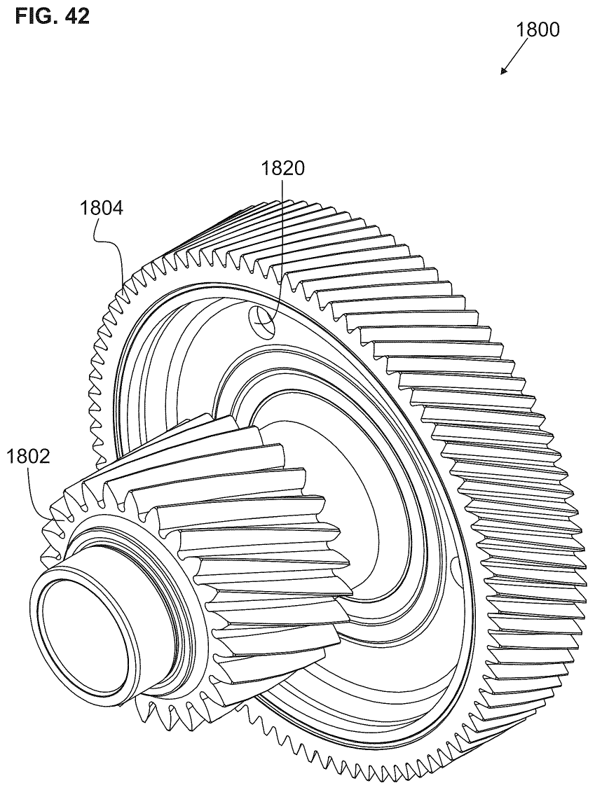

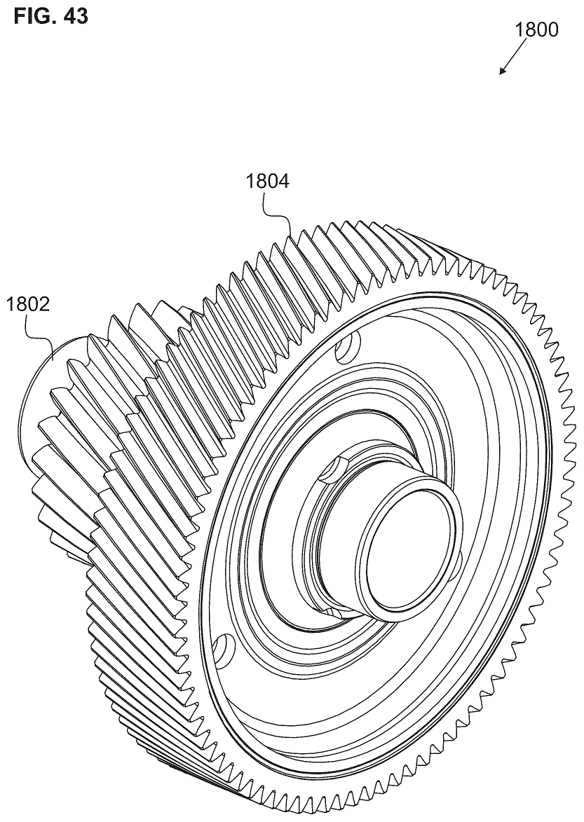

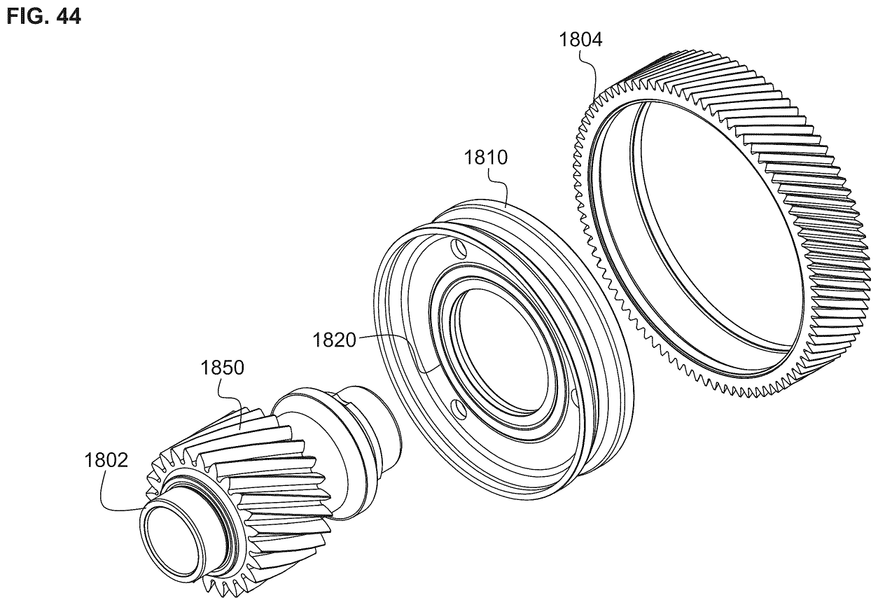

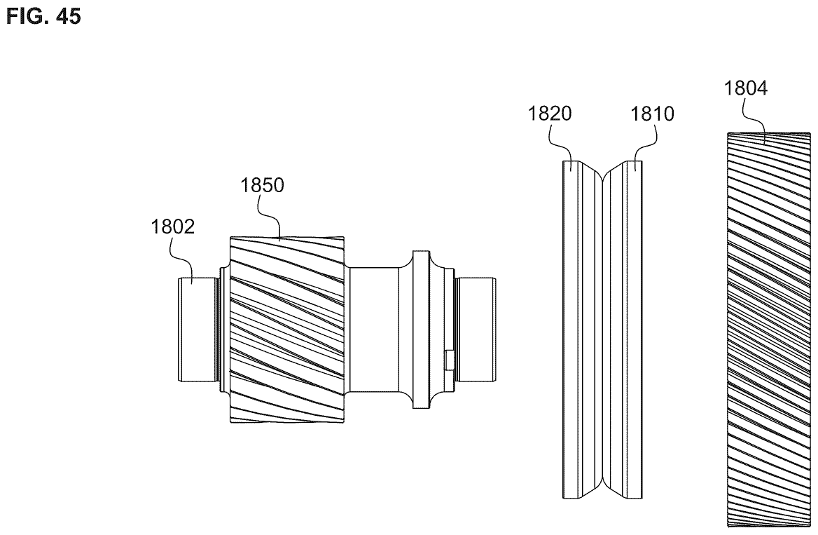

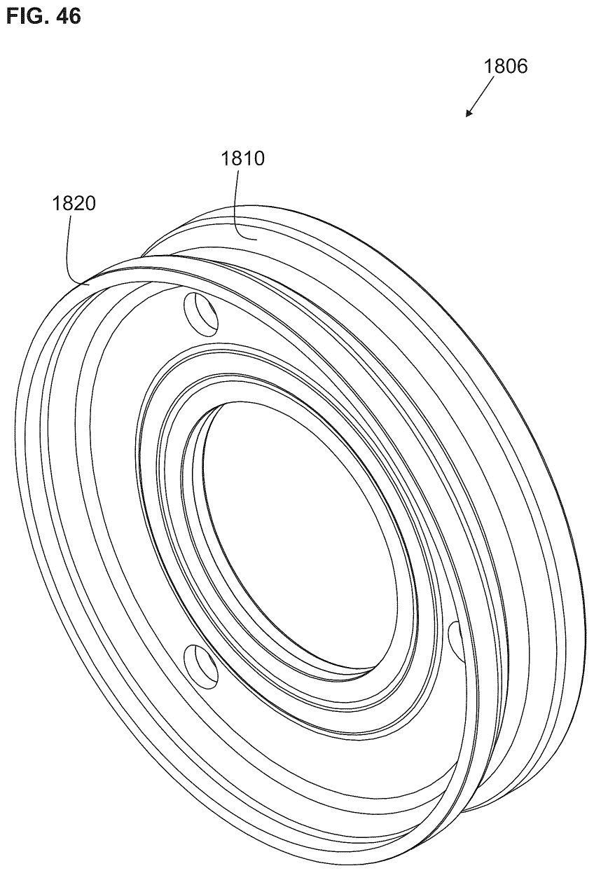

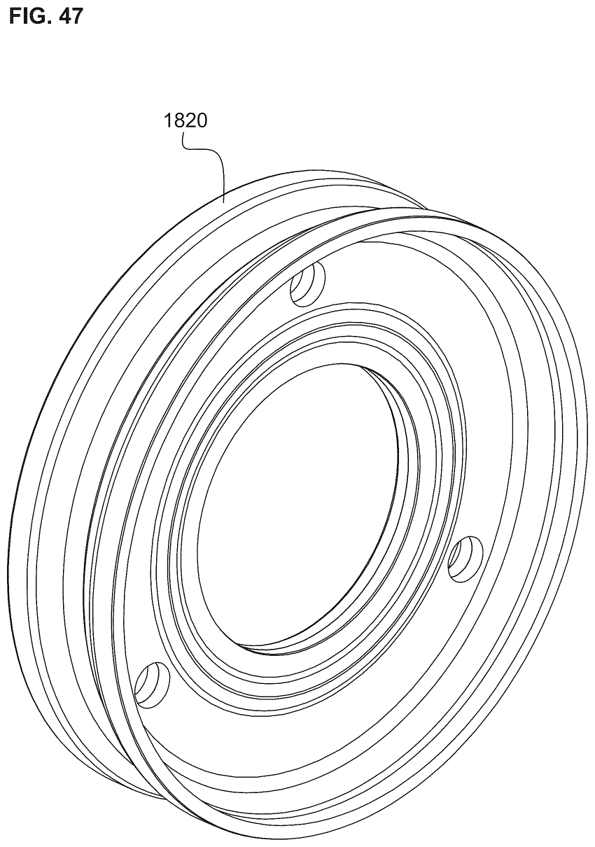

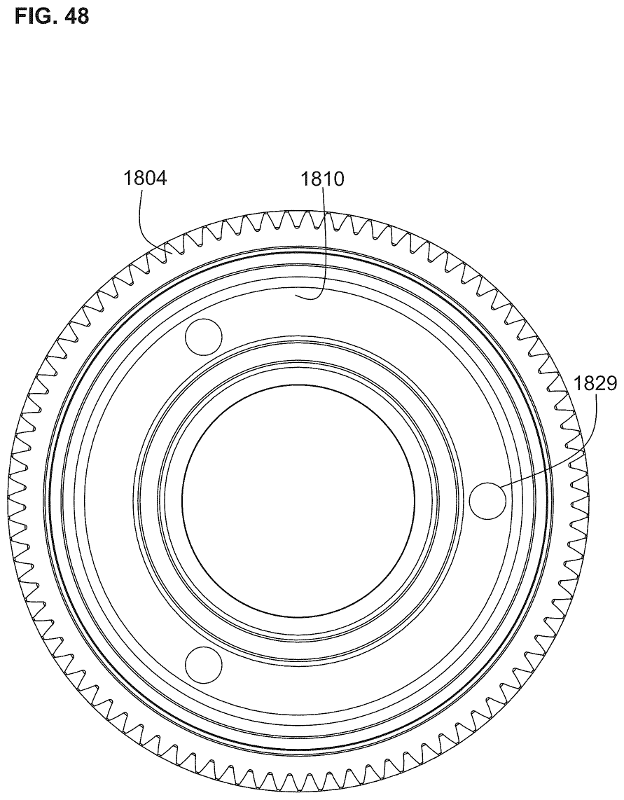

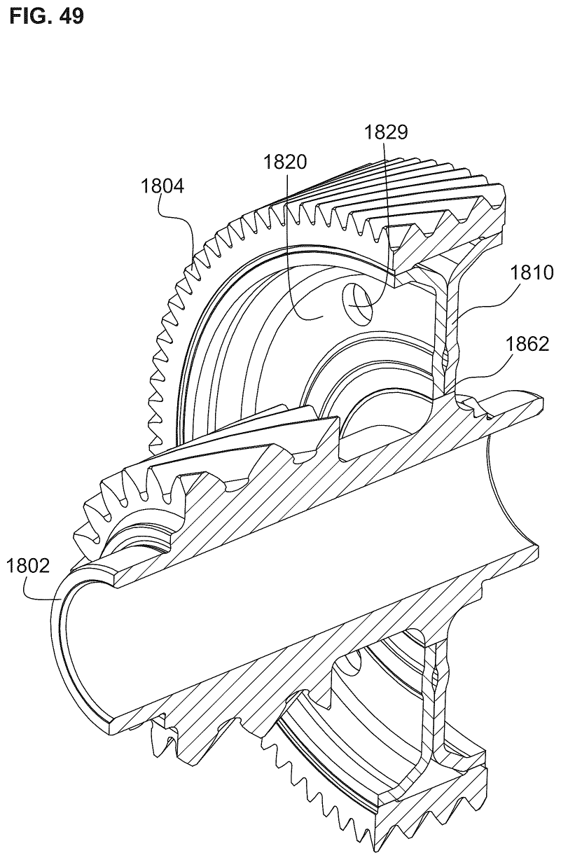

### Examples of FIGS. 42-50

FIGS. 42-50 depicts an example gear and shaft assembly 1800. Referring to FIG. 42, the gear and shaft assembly 1800 includes a shaft 1802, and ring gear 1804 and a dual disc assembly 1806. The disc assembly 1806 and ring gear 1804 may be referred to as a gear assembly or gear arrangement. The shaft 1802 including an axis A1 extending along the length of the shaft. The dual disc assembly 1806 including a first disc component 1810 and a second disc component 1820.

The first disc component 1810 may include a first end 1814 with an axially extending segment 1812a abutting and extending along an interior surface of the gear 1804, and a second end 1816 abutting and extending along an exterior surface of the shaft 1802, and a radially extending intermediate portion 1818. The radially extending intermediate portion 1818 can define a convex bend or bump 1118a in a first direction along the longitudinal axis. The second disc component 1820 may include a first end 1824 with an axially extending segment 1822a abutting and extending along an interior surface of the gear 1804, and a second end 1826 abutting and extending along an exterior surface of the shaft 1802, and a radially extending intermediate portion 1828. The radially extending intermediate portion 1828 can define a convex bend or bump 1828a in a second direction along the longitudinal axis toward a toothed region 1850 of the shaft. The convex bends 1818a and 1828a may align to define a gap 1830 between the first and second disc components 1810, 1820. The bends 1818a, 1828a provide mechanical strength to the discs. Further, the geometry of the first and second discs components 1810, 1820 allows for easier formation by stamping processes. The bends are positioned radially closer to the shaft than the ring gear. In other examples, the bends may be positioned radially closer to the ring than the shaft.

The first and second disc components can include apertures axially through each disc. The apertures 1829 can be positioned circumferentially around the shaft 1802. The apertures 1829 of each disc are both radially and circumferentially aligned. The apertures can be positioned between the bends 1818a,1828a and the ring gear. In other examples, the apertures can be positioned between the bends 1818a,1828a and the shaft 1802.

The ring gear 1804 includes a first side 1832 and a second side 1834. The ring gear further includes a first projection 1836 and a second projections 1838 extending from an interior surface 1840 of the ring gear 1804 at the first and second sides. A recessed area 1842 is defined between the projections. Each projection 1836, 1838 defines a surface for contacting the axially extending portion of the first ends of respective first and second disc components. The projections may each include reliefs 1844, 1846 for welding the first and second discs components to the ring gear.

The shaft 1802 can define a circumferential protrusion 1860 with a flat surface 1862 facing the ring gear. The second ends of the first and second disc components 1810, 1820 abut against and are welded to the flat surface 1862 of the circumferential protrusion. The first and second ends reduces the amount of welding to shaft required. The second ends of the first and second disc components define a width W6. The width W6 is equal to or less than the metal sheet thickness. Further, a length from the second end of the shaft to the intermediate portion can be reduced. The first and second disc components 1810, 1820 are welded together at the intermediate portions.

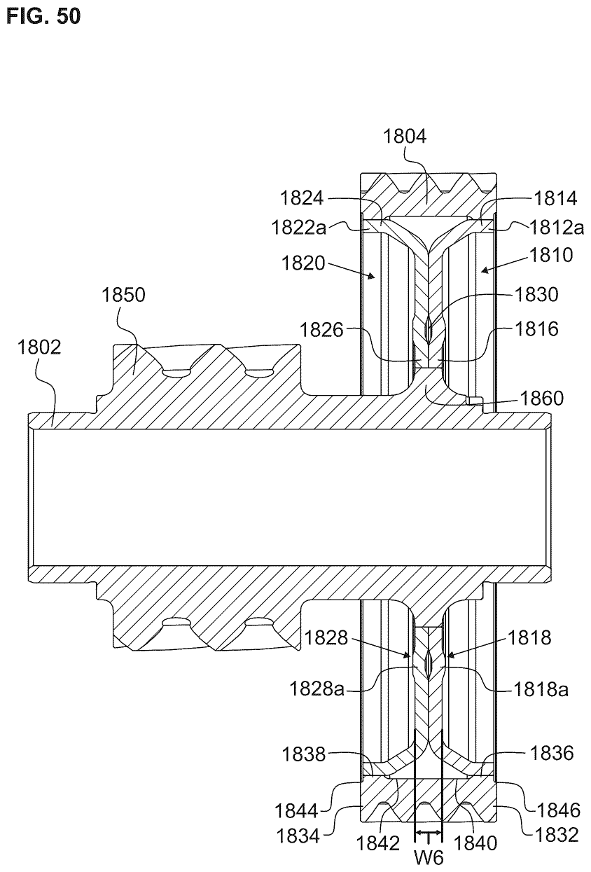

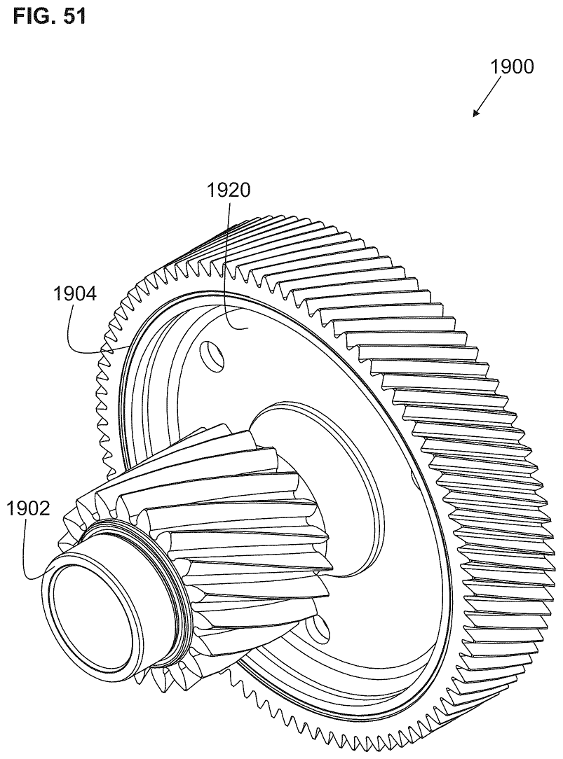

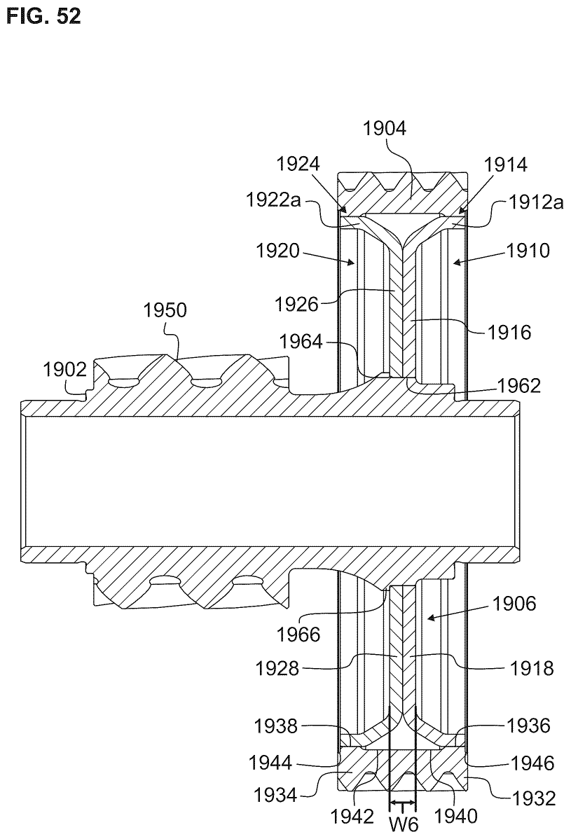

### Examples of FIGS. 50-52

FIGS. 42-50 depicts an example gear and shaft assembly 1900. Referring to FIG. 50, the gear and shaft assembly 1900 includes a shaft 1902, and ring gear 1904 and a dual disc assembly 1906. The disc assembly 1906 and ring gear 1904 may be referred to as a gear assembly or gear arrangement. The shaft 1902 including an axis A1 extending along the length of the shaft. The dual disc assembly 1906 including a first disc component 1910 and a second disc component 1920. The ring gear 1904 can have a similar structure as described in the examples of FIGS. 42-50.

The first disc component 1910 may include a first end 1914 with an axially extending segment 1912a abutting and extending along an interior surface of the gear 1904, and a second end 1916 abutting and extending along an exterior surface of the shaft 1902, and a radially extending intermediate portion 1918. The second disc component 1920 may include a first end 1924 with an axially extending segment 1922a abutting and extending along an interior surface of the gear 1904, and a second end 1926 abutting and extending along an exterior surface of the shaft 1802, and a radially extending intermediate portion 1928. Further, the geometry of the first and second discs components 1910, 1920 allows for easier formation by stamping processes. The bends are positioned radially closer to the shaft than the ring gear. In other examples, the bends may be positioned radially closer to the ring than the shaft. The first and second disc components may include apertures positioned circumferentially around the shaft 1902. The apertures of each disc are both radially and circumferentially aligned with each other.

The ring gear 1904 includes a first side 1932 and a second side 1934. The ring gear further includes a first projection 1936 and a second projections 1938 extending from an interior surface 1940 of the ring gear 1904 at the first and second sides. A recessed area 1942 is defined between the projections. Each projection 1936, 1938 defines a surface for contacting the axially extending portion of the first ends of respective first and second disc components. The projections may each include reliefs 1944, 1946 for welding the first and second discs components to the ring gear.

The shaft 1902 can define a circumferential protrusion 1960 with a flat surface 1962 facing the ring gear. The circumferential protrusion 1960 may also include a shoulder. 1964. The second ends of the first and second disc components 1810, 1820 abut against and are welded to the flat surface 1962 and the shoulder 1964 of the circumferential protrusion. The flat surface 1962 may be positioned radially inward from an outermost circumference 1966 of the circumferential protrusion 1960. The shoulder 1964 between the outermost circumference 1966 and the flat surface 1962. The circumferential protrusion 1960 may ramp to the outermost circumference 1966 and acts as a dam for welding material to protect the gear and shaft. The first and second ends reduces the amount of welding to shaft required. The second ends of the first and second disc components define a width W6. The width W6 is equal to or less than the metal sheet thickness. Further, a length from the second end of the shaft to the intermediate portion can be reduced. The first and second disc components 1810, 1820 are welded together at the intermediate portions.

Although various examples and examples are described herein, those of ordinary skill in the art will understand that many modifications may be made thereto within the scope of the present disclosure. Accordingly, it is not intended that the scope of the disclosure in any way be limited by the examples provided.

1. A gear and shaft assembly comprising:
a) a shaft extending along a longitudinal axis and presenting an outer surface;
b) a ring gear presenting an inner surface and having a plurality of radially outward facing teeth; and
c) a first disc component defining a radial inner end attached to the shaft outer surface and defining a radial outer end attached to the ring gear inner surface at an outer radial end, the radial outer end defining an axially extending portion;
d) a second disc component defining a radial inner end attached to the shaft outer surface and defining a radial outer end attached to the ring gear inner surface at an outer radial end, the radial outer end defining an axially extending portion;
e) wherein the axially extending portions of the first and second disc are welded to ring gear.

2. The gear and shaft assembly of claim 1, wherein the radial outer end of the first disc component extends in a first axial direction.

3. The gear and shaft assembly of claim 2, wherein the radial outer end of the second disc component extends in a second axial direction.

4. The gear and shaft assembly of claim 1, wherein the radial inner ends of the first and second disc components are welded to the shaft.

5. The gear and shaft assembly of claim 1, wherein the first and second disc components are identical to each other and are mirrored relative to each other.

6. The gear and shaft assembly of claim 1, wherein the shaft includes a circumferential protrusion having a flat surface opposite the inner surface of the ring gear.

7. The gear and shaft assembly of claim 6, wherein the circumferential protrusion is angled to an outermost circumference, and wherein the circumferential protrusion includes a shoulder defined between the outermost circumference and the flat, wherein the first radial ends are coupled to the flat surface and the shoulder.

8. The gear and shaft assembly of claim 1, wherein the first and second disc components are oriented so that the first and second disc components are welded together along a radially extending surface.

9. A gear and shaft assembly comprising:
a) a shaft extending between a first end and a second end;
b) a ring gear; and
c) at least one disc operatively coupling the ring gear to the shaft and extending between a first radial end proximate the shaft and a second radial end proximate the ring gear, wherein the second radial end extend in an axial direction towards the shaft first end, and wherein the at least one disc has a middle portion defining a recess extending in a direction toward the shaft second end.

10. The gear and shaft assembly of claim 9, wherein the first radial end of the at least one disc is directly attached to the shaft and extends in an axial direction towards the first shaft end.

11. The gear and shaft assembly of claim 10, wherein the second radial end of the at least one disc is directly attached to the ring gear.

12. The gear and gear and gear assembly of claim 9, wherein the at least one disc is a single disc.

13. The gear and gear assembly of claim 12, wherein the single disc has a C-shaped cross-sectional shape.

14. The gear and gear assembly of claim 12, wherein the single disc has an X-shaped cross-sectional shape.

15. The gear and shaft assembly of claim 9, wherein the at least one disc comprises a dual disc configuration, the dual disc configuration comprising:
a) a first disc; and
b) a second disc joined to the first disc.

16. The gear and shaft assembly of claim 15, wherein the first disc and the second disc are oriented so that the first disc and the second disc are joined along a radially extending surface.

17. The gear and shaft assembly of claim 15, wherein the first disc and the second disc are identical to each other.

18. The gear and shaft assembly of claim 15, wherein each disc has a first side and a second side separated by a thickness, and wherein each disc is attached to both the ring gear and the shaft on the first side.

19. The gear and shaft assembly of claim 15, wherein the second radial ends are curved to define an axially extending portion.

20. The gear and shaft assembly of claim 19, wherein the shaft includes a circumferential protrusion having a flat surface opposite an inner surface of the ring gear, and wherein the first radial ends are coupled to the flat surface and the shoulder.
